(19) United States
(12) Patent Application Publication
(10) Pub. No.: US 2024/0013617 A1
(43) Pub. Date: Jan. 11, 2024

(54) MACHINE-LEARNING BASED MESSAGING AND EFFECTIVENESS DETERMINATION IN GAMING SYSTEMS

(71) Applicant: LNW Gaming, Inc., Las Vegas, NV (US)

(72) Inventors: Christopher P. ARBOGAST, Reno, NV (US); Robert Thomas DAVIS, Reno, NV (US); Bradley LINDBERG, Reno, NV (US); Sandeep MOHANADASAN, Kerala (IN); Rajesh SUBRAMANIAN, Tamil Nadu (IN)

(21) Appl. No.: 18/344,046

(22) Filed: Jun. 29, 2023

Related U.S. Application Data
(60) Provisional application No. 63/359,573, filed on Jul. 8, 2022.

(51) Int. Cl. G07F 17/32

(52) U.S. Cl. CPC G07F 17/3239; G07F 17/3241

(57) ABSTRACT

Systems and methods are provided for determining an effectiveness of one of more messages based on machine-learning analysis of images of a gaming environment. For example, a gaming system presents, via an output device at a gaming table during an evaluation period, messages related to a game feature. The game feature is available at one or more participant stations at the gaming table. The system further detects, for the evaluation period based on analysis of the images of the gaming table by one or more machine learning models, gaming activity associated with the game feature. The system further determines, in response to comparison of message data to gaming activity data, a statistical correlation between presentation of the messages and the gaming activity. Furthermore, the system computes, based on the statistical correlation, a message effectiveness score for one or more of the messages in relation to the game feature.

### RELATED APPLICATIONS

This patent application claims priority benefit to U.S. Provisional Patent Application No. 63/359,573 filed Jul. 8, 2022. The 63/359,573 application is hereby incorporated by reference herein in its entirety.

### COPYRIGHT

A portion of the disclosure of this patent document contains material which is subject to copyright protection. The copyright owner has no objection to the facsimile reproduction by anyone of the patent disclosure, as it appears in the Patent and Trademark Office patent files or records, but otherwise reserves all copyright rights whatsoever. Copyright 2023, LNW Gaming, Inc.

### FIELD

The present disclosure relates generally to gaming systems, apparatus, and methods and, more particularly, to gaming activity detection in a gaming environment and related messaging.

### BACKGROUND

Casino gaming environments are dynamic environments in which people, such as players, casino patrons, casino staff, etc., take actions that affect the state of the gaming environment, the state of players, etc. For example, a player may use one or more physical tokens to place wagers on the wagering game. A player may perform hand gestures to perform gaming actions and/or to communicate instructions during a game, such as making gestures to hit, stand, fold, etc. Further, a player may move physical cards, dice, gaming props, etc. A multitude of other actions and events may occur at any given time. To effectively manage such a dynamic environment, the casino operators may employ one or more tracking systems or techniques to monitor aspects of the casino gaming environment, such as credit balance, player account information, player movements, game play events, and the like. The tracking systems may generate a historical record of these monitored aspects to enable the casino operators to facilitate, for example, a secure gaming environment, enhanced game features, and/or enhanced player features (e.g., rewards and benefits to known players with a player account).

Some gaming systems can perform object tracking in a gaming environment. For example, a gaming system with a camera can capture an image feed of a gaming area to identify certain physical objects or to detect certain activities such as betting actions, payouts, player actions, etc. Some gaming systems also incorporate projectors. For example, a gaming system with a camera and a projector can use the camera to capture images of a gaming area to electronically analyze to detect objects/activities in the gaming area. The gaming system can further use the projector to project related content into the gaming area.

However, one challenge to such gaming systems is determining the utility and/or effectiveness of the system. For example, although the gaming system can track the location of certain objects using the camera, certain systems have a challenge using the information that was detected to provide feedback about detected gaming activity, or to determine the effectiveness of any feedback about gaming activity over time.

Accordingly, a new tracking system that is adaptable to the challenges of dynamic, real-time casino gaming environments is desired.

### SUMMARY

According to one aspect of the present disclosure, a gaming system is provided for determining an effectiveness of one of more messages based on machine-learning analysis of images of a gaming environment. For example, a gaming system presents, via an output device at a gaming table during an evaluation period, messages related to a game feature available at one or more participant stations at the gaming table. The system further detects, for the evaluation period based on analysis of the images of the gaming table by one or more machine learning models, gaming activity associated with the game feature. The system further determines, in response to comparison of message data to gaming activity data, a statistical correlation between presentation of the messages and the gaming activity. Furthermore, the system computes, based on the statistical correlation, a message effectiveness score for one or more of the messages in relation to the game feature.

Additional aspects of the invention will be apparent to those of ordinary skill in the art in view of the detailed description of various embodiments, which is made with reference to the drawings, a brief description of which is provided below.

### BRIEF DESCRIPTION OF THE DRAWINGS

Detailed discussion of embodiments directed to one of ordinary skill in the art are set forth in the specification, which makes reference to the appended figures, in which:

FIG. 1 is a diagram of an example gaming system according to one or more embodiments of the present disclosure.

FIG. 2 is a diagram of an exemplary gaming system according to one or more embodiments of the present disclosure.

FIG. 3 is a flow diagram of an example method according to one or more embodiments of the present disclosure.

FIG. 4 is a flow diagram of an example method according to one or more embodiments of the present disclosure.

FIGS. 5A, 5B, 6, 7A, 7B, 7C, 7D, and 7E are diagrams of an exemplary gaming system associated with the data flow shown in FIG. 4 according to one or more embodiments of the present disclosure.

FIG. 8 is a diagram of a gaming system for implementing embodiments of wagering games in accordance with the present disclosure.

FIG. 9 is a diagram of a gaming system for implementing embodiments of wagering games including a live dealer feed in accordance with the present disclosure.

FIG. 10 is a diagram of a computer for acting as a gaming system for implementing embodiments of wagering games in accordance with the present disclosure.

FIG. 11 is a diagram of a gaming-machine architecture according to an embodiment of the present disclosure.

### DETAILED DESCRIPTION

Reference now will be made in detail to embodiments, one or more examples of which are illustrated in the drawings. Each example is provided by way of explanation of the embodiments, not limitation of the present disclosure. In fact, it will be apparent to those skilled in the art that various modifications and variations can be made to the embodiments without departing from the scope or spirit of the present disclosure. For instance, features illustrated or described as part of one embodiment can be used with another embodiment to yield a still further embodiment. Thus, it is intended that aspects of the present disclosure cover such modifications and variations.

As referenced herein, the term “player” refers to an entity such as, for example, a human, a user, an end-user, a consumer, an organization (e.g., a company), a computing device and/or program (e.g., a processor, computing hardware and/or software, an application, etc.), an agent, a machine learning (ML) and/or artificial intelligence (AI) algorithm, model, system, and/or application, and/or another type of entity that can implement one or more embodiments of the present disclosure as described herein, illustrated in the accompanying drawings, and/or included in the appended claims. As referenced herein, the terms “or” and “and/or” are generally intended to be inclusive, that is (i.e.), “A or B” or “A and/or B” are each intended to mean “A or B or both.” As referred to herein, the terms “first,” “second,” “third,” etc. can be used interchangeably to distinguish one component or entity from another and are not intended to signify location, functionality, or importance of the individual components or entities. As used herein, the terms “couple,” “couples,” “coupled,” and/or “coupling” refer to chemical coupling (e.g., chemical bonding), communicative coupling, electrical and/or electromagnetic coupling (e.g., capacitive coupling, inductive coupling, direct and/or connected coupling, etc.), mechanical coupling, operative coupling, optical coupling, and/or physical coupling.

While this invention is susceptible of embodiment in many different forms, there is shown in the drawings, and will herein be described in detail, preferred embodiments of the invention with the understanding that the present disclosure is to be considered as an exemplification of the principles of the invention and is not intended to limit the broad aspect of the invention to the embodiments illustrated. For purposes of the present detailed description, the singular includes the plural and vice versa (unless specifically disclaimed); the words “and” and “or” shall be both conjunctive and disjunctive; the word “all” means “any and all”; the word “any” means “any and all”; and the word “including” means “including without limitation.”

For purposes of the present detailed description, the terms “wagering game,” “casino wagering game,” “gambling,” “slot game,” “casino game,” and the like include games in which a player places at risk a sum of money or other representation of value, whether or not redeemable for cash, on an event with an uncertain outcome, including without limitation those having some element of skill. In some embodiments, the wagering game involves wagers of real money, as found with typical land-based or online casino games. In other embodiments, the wagering game additionally, or alternatively, involves wagers of non-cash values, such as virtual currency, and therefore may be considered a social or casual game, such as would be typically available on a social networking web site, other web sites, across computer networks, or applications on mobile devices (e.g., phones, tablets, etc.). When provided in a social or casual game format, the wagering game may closely resemble a traditional casino game, or it may take another form that more closely resembles other types of social/casual games.

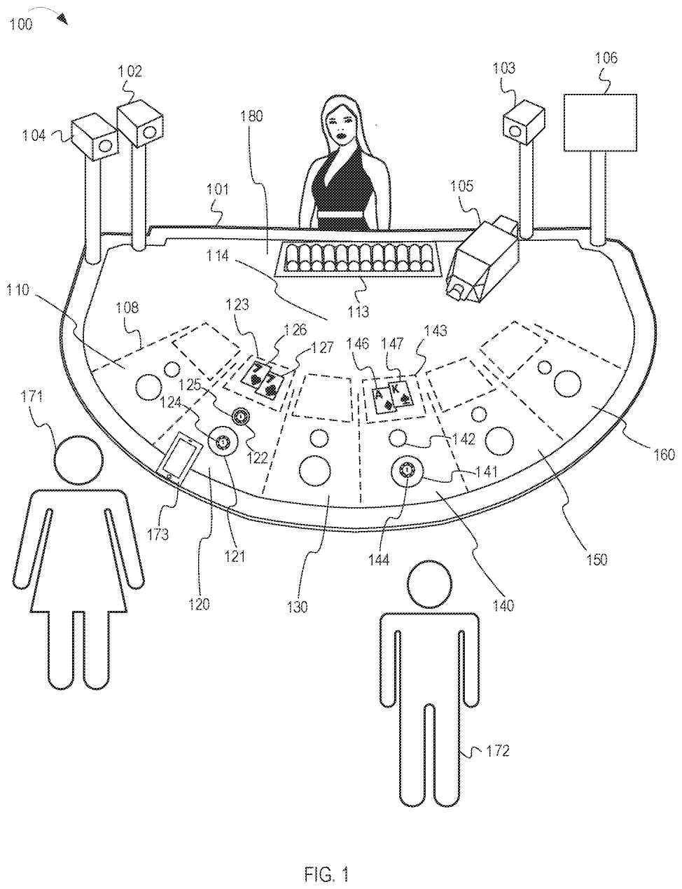

FIG. 1 is a diagram of an example gaming system 100 according to one or more embodiments of the present disclosure. The gaming system 100 includes a gaming table 101, at least one camera (e.g., camera 102 and camera 103) and a projector 104. The camera(s) 102 and/or 103 each captures a stream of images of a gaming area, such as an area encompassing a top surface of the gaming table 101, as well as any relevant surrounding areas, such positions where participants are located. The stream comprises a frame of image data. The projector 104 is configured to project images of gaming content. The projector 104 projects the images of the gaming content toward the surface of the gaming table 101 relative to objects in the gaming area. The camera(s) 102 and/or 103 are positioned above the surface of the gaming table 101 and are to the left and right of a dealer station 180. The camera 102, for example has a first camera perspective (e.g., field of view or angle of view) of the gaming area. The camera 103 has a second camera perspective of the gaming area. The first camera perspective and/or second camera perspective may be referred to in this disclosure more succinctly as one or more viewing perspectives. For example, the camera 102 has a lens that is pointed at the gaming table 101 in a way that views portions of the surface relevant to game play and that views game participants (e.g., players, dealer, back-betting patrons, etc.) positioned around the gaming table 101. The camera 103 also has a lens that is pointed at the gaming table 101, but from a different angle, or viewing perspective, as that of the camera 102. Hence, the camera(s) 102 and/or 103 can capture multiple angles of the gaming area to analyze. Analysis of multiple angles provides for more accurate object detection and/or machine-learning predictions.

The projector 104 is also positioned above the gaming table 101, and to the right of the dealer station 180. The projector 104 has a third perspective (e.g., projection direction, projection angle, projection view, or projection cone) of the gaming area. The third perspective may be referred to in this disclosure more succinctly as a projection perspective. For example, the projector 104 has a lens that is pointed at the gaming table 101 in a way that projects (or throws) images of gaming content onto substantially similar portions of the gaming area that the camera(s) 102 and/or 103 view. Because the lenses for the camera(s) 102 and 103 are not in the same location as the lens for the projector 104, the camera perspective is different from the projection perspective. The gaming system 100, however, is a self-referential gaming table system that adjusts for the difference in perspectives. For instance, the gaming system 100 is configured to detect, in response to electronic analysis of the images taken by the camera(s) 102 and/or 103, one or more points of interest that are substantially planar with the surface of a gaming table 101. The gaming system 100 can further automatically transform locations values for the detected point(s) from the camera perspective to the projection perspective, and vice versa, such that they substantially, and accurately, correspond to each other.

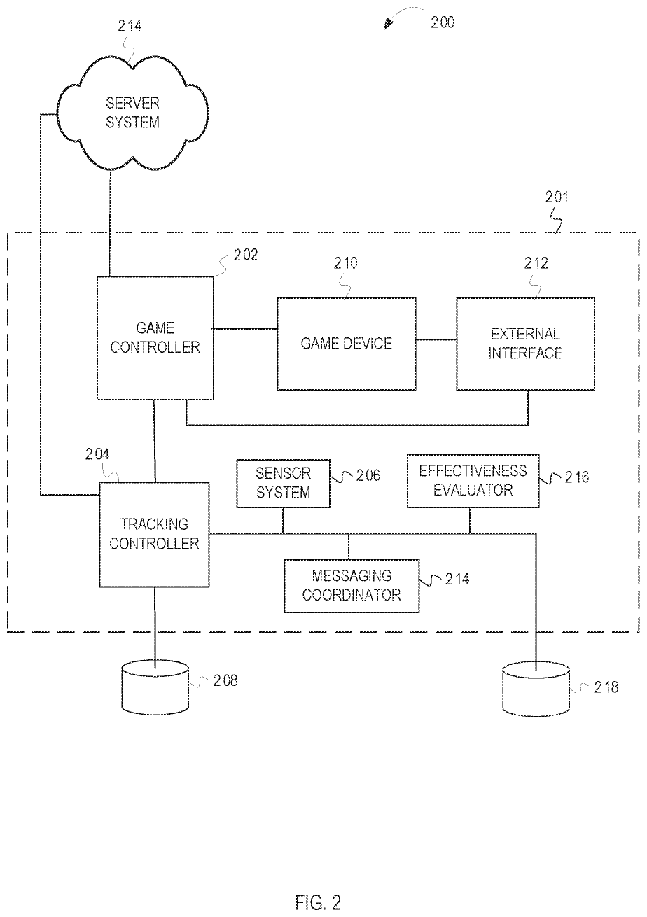

In some embodiments, the gaming system 100 automatically detects physical objects as points of interest based on electronic analysis of one or more images of the gaming area, such as via feature set extraction, object classification, etc. performed by one or more machine-learning models (e.g., via tracking controller 204). In some examples described further herein, the one or more machine-learning models is/are referred to, by example, as neural network models. The gaming system 100 includes one or more processors (e.g., a tracking controller 204 described in more detail in FIG. 2). The tracking controller 204, for example, is configured to monitor the gaming area (e.g., monitor physical objects within the gaming area), and determine a relationship between one or more of the objects. The tracking controller 204 can further receive and analyze collected sensor data (e.g., receives and analyzes the captured image data from the camera(s) 102 and/or 103) to detect and monitor physical objects. The tracking controller 204 can establish data structures relating to various physical objects detected in the image data. For example, the tracking controller 204 can apply one or more image neural network models during image analysis that are trained to detect aspects of physical objects. In at least some embodiments, each model applied by the tracking controller 204 may be configured to identify a particular aspect of the image data and provide different outputs for any physical objected identified such that the tracking controller 204 may aggregate the outputs of the neural network models together to identify physical objects as described herein. The tracking controller 204 may generate data objects for each physical object identified within the captured image data. The data objects may include identifiers that uniquely identify the physical objects such that the data stored within the data objects is tied to the physical objects. The tracking controller 204 can further store data in a database, such as the tracking database system 208 in FIG. 2.

In some embodiments, the gaming system 100 automatically detects an automorphing relationship (e.g., a homography or isomorphism relationship) between observed points of interest to transform between projection spaces and linear spaces. For instance, the gaming system 100 can detect points of interest that are physically on the surface of the gaming table 101 and deduce a spatial relationship between the points of interest. For instance, the gaming system 100, can detect one or more physical objects resting, printed, or otherwise physically positioned on the surface, such as objects placed at specific locations on the surface in a certain pattern, or for a specific purpose. In some instances, the tracking controller 204 determines, via electronic analysis, features of the objects, such as their shapes, visual patterns, sizes, relative locations, numbers, displayed identifiers, etc. For example, the tracking controller 204 may identify a set of ellipses in the captured image and deduce that they are a specific type of bet zone (e.g., betting circles). For instance, as shown in FIG. 1, the gaming table 101 includes a first participant station 110, a second participant station 120, a third participant station 130, a fourth participant station 140, a fifth participant station 150 and a sixth participant station 160 (arranged symmetrically around the dealer station 180) at which participants (e.g., players) can play a wagering game at the gaming table 101. For example, at the gaming table 101 are two individuals 171 and 172. The first individual 171 is positioned at the second participant station 120. The second individual 172 is positioned at the fourth participant station 140. Printed onto the surface of the gaming table 101 (e.g., onto the felt covering of the gaming table 101) are twelve bet zones (or bet spots). For example, the second participant station 120 includes, as bet zones, a main bet spot 121 (i.e., for a main game played at the gaming table 101) and a secondary bet spot 122 (e.g., for a bonus bet, side bet, or secondary game bet). Likewise, the fourth participant station 140 includes, as bet zones, a main bet spot 141 and a secondary bet spot 142. Based on that information (e.g., twelve bet zones), the tracking controller 204 may look up a library of gaming table layouts of a detected manufacturer and obtain, in response to detecting the configuration, a template that has precise distances and positions of printed features on a gaming surface fabric, such as a fabric that has the given number of detected bet spots arranged in an arc shape. Thus the positions and orientations of the printed objects have a known relationship in a geometric plane (i.e., of the surface of the gaming table 101) that occurs when the fabric is placed and affixed to the top of the gaming table 101 (such as when a gaming fabric top is placed or replaced within the casino (e.g., for initial setup, when it becomes soiled or damaged, etc.). Thus, the tracking controller 204 detects and identifies the printed features and uses them as identifiers due to their shape and pattern which relates to a known relationship in spatial dimensions and in purpose (e.g., different bet circles represent different points of interest on the plane of the gaming surface, each with a different label and function during the wagering game). In some embodiments, the tracking controller 204 can also detect unmarked areas and/or draw (e.g., via a virtual scene overlay) boundaries of certain unmarked areas. For instance, the tracking controller 204 can detect boundaries 108 for the participant stations 110, 120, 130, 140, 150, and 160. In one embodiment, the boundaries 108 are printed onto the felt covering. Hence, a machine learning model can detect the physically printed boundaries from captured images. In other embodiments, however, the boundaries 108 are not printed. Thus, the tracking controller 204, via use of the machine learning model, can predict the locations of the boundaries 108 based on distances and known locations of other printed objects and/or other table features depicted in captured images. For example, the tracking controller 204 can predict the boundaries 108 based on detected objects (e.g., detected center points of the circular bet spots) as well as known information about the table layout such as the known position of the bet spots relative to a known table feature (e.g., the known position of bet spots to a chip-tray cut out on the layout), the known symmetry of the placement of the bet spots on the layout, the known distances of bet spots from each other, etc. Using the detected and known information, the tracking controller 204 can, via the machine learning model, draw the boundaries 108 as virtual objects on a virtual scene overlay, on a virtual graph, etc. used to accurately isolate the general area where gaming activity is expected to occur for each individual participant station.

In some instances, the tracking controller 204 detects, or in some instances estimates, a centroid for any of detected objects/points of interest (e.g., the tracking controller 204 can estimate centroids for a chip tray 113 and/or for the bet spots (e.g., for main bet spot 121, secondary bet spot 122, main bet spot 141, and secondary bet spot 142)). In some instances, the tracking controller 204 can detect, or estimate, the centroid of each of the ellipses in the captured images by binarizing the digitalized image(s) of the ellipse(s) (e.g. converting the pixels of the image of an ellipse from an 8-bit grayscale image to a 1-bit black and white image) and determining the centroid by using a weighted average of image pixel intensities. The gaming system 100 can use the centroids of the ellipses as references points.

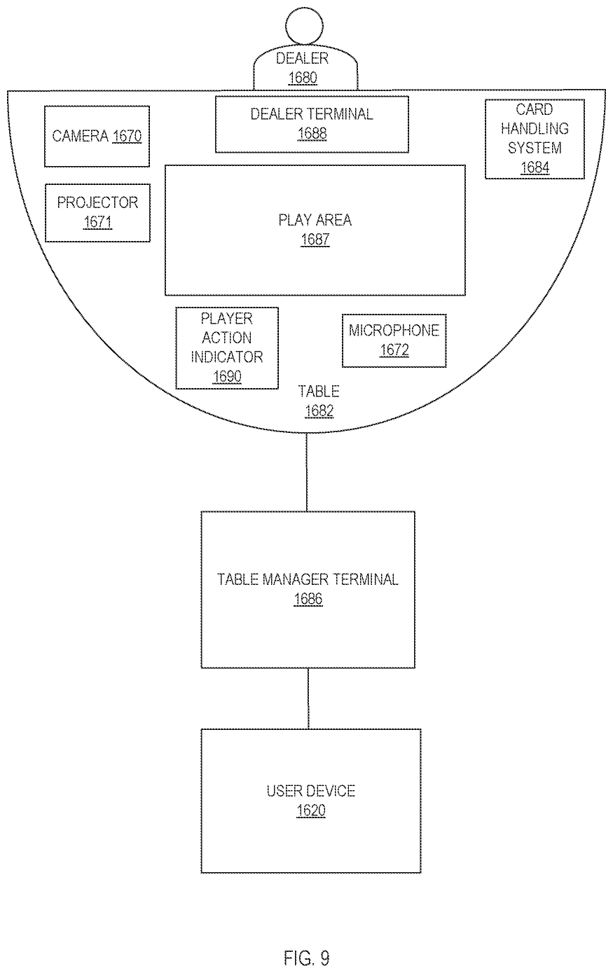

In some instances, the tracking controller 204 can automatically detect, as points of interest, native topological features of the surface of the gaming table 101. For instance, the tracking controller 204 can detect one or more points of interest associated with the chip tray 113 positioned at the dealer station 180 (see also FIG. 9, dealer terminal 1688). The chip tray 113 can hold gaming tokens, such as gaming chips, tiles, etc., which a dealer can use to exchange a player's money for physical gaming tokens. Some objects may be included at the gaming table 101, such as gaming tokens (e.g., chips 124, 125, and 144), cards (cards 126, 127, 146, and 147), a card handling device 105 (e.g., a shuffler or shoe), etc. Other objects may be included at the table (e.g., dice, props, etc.) but are not shown in FIG. 1 for simplicity of description. An additional area 114 is available for presenting (e.g., projecting) gaming content relevant to some elements of a wagering game that are common, or related, to any or all participants.

The tracking controller 204 detects the features of the bet zones. For instance, the tracking controller 204 detects a number of ellipses that appear in the image(s) of the gaming table 101. The gaming system 100 can also detect the ellipses relative sizes, their arrangement relative to a chip tray 113, their locations relative to each other, etc.

In some instances, the tracking controller 204 can automatically detect one or more points of interest that are projected onto the surface of the gaming table 101 by the projector 104. In one example, the gaming system 100 can automatically triangulate a projection space based on known spatial relationships of points of interest on the surface. For example, in some embodiments, the tracking controller 204 utilizes polygon triangulation of the detected points of interest to generate a virtual mesh associated with a virtual scene modeled to the projection perspective. More specifically, the tracking controller 204 can project images of a set of one or more specific objects or markers (as points of interest) onto the surface and use the marker(s) for self-reference and auto-calibration, as described, for example, in U.S. patent application Ser. No. 17/319,841, filed May 13, 2021, which is hereby incorporated by reference herein in its entirety. For instance, the tracking controller 204 can transform, via a projection transformation, an appearance of the markers from the projection space visible in the images of the gaming table 101 to a known linear (e.g., Euclidean) space associated with the grid, such as a virtual, or augmented reality layer depicting a virtual scene with gaming content mapped relative to locations in the grid (e.g., see theSer. No. 17/319,841 application).

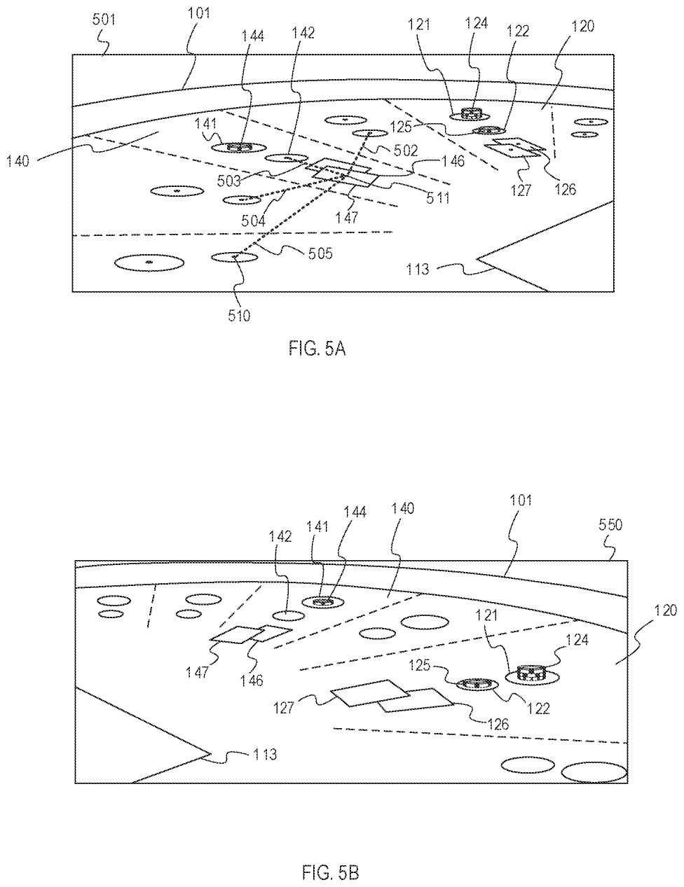

The tracking controller 204 is further configured to detect the placement of cards at the participant stations to determine which participant stations are in use. For example, after the cards 126 and 127 are dealt from the card handling device 105, the tracking controller 204 detects the presence of the cards 126 and 127 at the second participant station 120. For example the tracking controller 204 captures first images of the gaming table 101 (e.g., using the camera(s) 102 and/or 103) and analyzes the first images via a first machine learning model. In one example, the tracking controller 204 detects that the cards 126 and 127 are dealt to section 123, which is an area (either marked or unmarked) on the surface of the gaming table 101 that pertains to where cards are dealt for the second participant station 120. Furthermore, by way of example, after the cards 146 and 147 are dealt from the card handling device 105, the tracking controller 204 can detect the presence of the cards 146 and 147 at a section 143 pertaining to the fourth participant station 120. Section 143 is an area (either marked or unmarked) on the surface of the gaming table 101 that pertains to where cards are dealt for the fourth participant station 120. For example, the tracking controller 204 detects the presence of the cards 126, 127, 146, or 147 by analyzing the first images of the gaming table 101 via the first machine learning model and/or by taking additional images of the gaming table 101 (e.g., using the camera(s) 102 and/or 103) and analyzing the additional images via the first machine learning model. The first machine learning model is trained, according to the camera perspectives of the camera(s) 102 and/or 103, to detect the placement or position of playing cards at a participant station based on images of standard sized playing cards dealt to the participant stations. The first machine learning model can be trained to distinguish areas or locations to which cards are dealt. For example, the areas 123 and 143 may not be marked or printed on the felt surface of the gaming table 101. Instead, the first machine learning model can be trained to detect the proximity of dealt cards to one of the printed features of each of the participant stations. For example, the first machine learning model can be trained to detect the location of the area 123 based, at least in part, on the proximity of the dealt cards to the secondary bet spot 122. For example, because the cards 126 and 127 were dealt closest to the secondary bet spot 122 (which belongs to the second participant station 120), then the first machine learning model can use the proximity of the cards 126 and 127 to the secondary bet spot 122 as a feature to predict that the cards 126 and 127 were dealt to the second participant station 120. In another example, a machine learning model (e.g., a second machine learning model) can be trained to detect which of the participant stations has betting activity as opposed to those that do not. Based, at least in part on the detected betting activity, the tracking controller 204 can deduce the participant station to which the cards were dealt. For example, in FIG. 1, the tracking controller 204 detects (e.g., via the second machine learning model) that the first participant station 110 and the third participant station 130 do not have any betting activity (e.g., detects that there are no tokens placed within the betting spots for the first participant station 110 or for the third participant station 130). The tracking controller 204, however, detects that the second participant station 120 has tokens (e.g., chips 124 and 125) placed within the main bet spot 121 and the secondary bet spot 122. The second machine learning model can evaluate the betting activity as a one or more features, variables, parameters, hyperparameters, etc. of a neural network algorithm. For example, the second machine learning model evaluates the betting activity at the second participant station 120 and the lack of betting from the surrounding participant stations 110 and 130 to predict that the cards 126 and 127 were dealt to the second participant station 120. In one example, the first machine learning model is configured to receive, as an input, betting information from the second machine learning model. Hence, the first machine learning model and the second machine learning model can work in combination to detect gaming activity at particular participant stations. FIG. 5A below describes an example of matching dealt cards to participant stations based on distances of detected centroids.

Referring still to FIG. 1, as mentioned, the tracking controller 204 is configured to detect (as the gaming activity) betting that occurs at participant stations. The tracking controller 204 stores the betting activity to keep a history (e.g., in table 730) of gaming activity that occurs for particular game features for particular participant stations or players. For instance, the tracking controller 204 detects (e.g., via the second machine learning model) placement of bets in the bet spots 121, 122, and 141. The tracking controller 204 can thus attribute, to the second participant station 120, two types of betting activity: a “main” bet, or rather a bet on the main game feature (i.e., the main bet spot 121); and a “secondary” bet, or rather a bet on the secondary game feature (i.e., the secondary bet spot 122). On the other hand, the tracking controller 204, attributes, to the fourth participant station 140, one type of betting activity and one type of non-betting activity: a main bet (i.e., the bet in the main bet spot 141) and no betting activity (also referred to as “non-betting” activity) for the secondary bet (i.e., a lack of placement of a bet in the secondary bet spot 142). In some embodiments, the gaming system 100 (e.g., via the tracking controller 204, the messaging coordinator 214, or the effectiveness evaluator 215) refers to the types of gaming activity that occurred when generating a feedback type of message as well as when comparing first-occurring gaming activity to later-detected gaming activity (referred to herein as “second-occurring” gaming activity). The tracking controller 204 also detects lack of placement of bets from the first participant station 110, the third participant station 130, the fifth participant station 150 and the sixth participant station 160. In some embodiments, the tracking controller 204 can also detect the presence and/or identities and of the individuals 171 and 172 or can track their locations at the participant stations. The tracking controller 204 can also store and attribute the gaming activity to the individuals 171 and 172, such as to tracking player activity via a casino management program and/or to track a customer loyalty account or player profile via a bonusing program. One example of a casino management program is the ACSC™ casino management system by Light & Wonder, Inc. or the TableView™ table management solution by Light & Wonder, Inc. An example of a bonusing program includes the Elite Bonusing Suite™ by Light & Wonder, Inc. In some embodiments, the tracking controller 204 can automate player ratings (e.g., via integration with the TableView™ PA product), such as by accurately ascribing the gaming activity (e.g., bets) for each participant station to a player account and/or profile (e.g., attributes bets to each player's seat position at the gaming table 101).

Furthermore, the tracking controller 204 can detect (e.g., via a third machine learning model) the value of the dealt cards 126, 127, 146, and 147. The tracking controller 204 can further compare the values of the dealt cards to game rules, a pay table, etc. to determine game outcome data for each of the participating participant stations. The tracking controller 204 stores the game outcome data as part of the gaming activity. The game outcome data can include actual card values, game outcome labels (e.g., “win,” “loss,” “near-miss,” etc.), game type or categories (e.g., “main/primary game,” “secondary game,” etc.), and so forth. The system 100 can refer to game outcome data when generating messages as well as when comparing first-occurring gaming activity to second-occurring gaming activity. In one example, the first machine learning model and/or the second machine learning model are configured to receive, as an input, card values from the third machine learning model. Hence, the first machine learning model, the second machine learning model, and the third machine learning model, can work in combination to detect gaming activity at particular participant stations.

The gaming system 100 (e.g., via the tracking controller 204, the effectiveness evaluator 216, etc.) is configured to analyze the timing of occurrence of the gaming activity (related to a game feature) against the timing of presentation of messages pertinent to (e.g., targeted to) the game feature and, based on the analysis determine a statistical correlation. Based on the statistical correlation, the gaming system 100 is configured to generate a message effectiveness score (also referred to herein as an “effectiveness score” or “score) for a message (e.g. to a type of message) and, in response, use the message effectiveness score. One way to use the effectiveness score is to generate a report showing the comparison of effectiveness scores of certain messages. Another way to use the effectiveness score is to generate (e.g., via messaging coordinator 214 shown in FIG. 2) one or more “feedback” messages pertinent to the game feature(s) available at the gaming table 101, etc. For instance, the gaming system 100 can utilize the effectiveness score to rotate in new messages. For example, at the end of an evaluation period (e.g., at the end of a month), the gaming system 100 (e.g., via tracking controller 204) can automatically remove messages that did not perform well (e.g., remove messages with relatively low effectiveness scores). The tracking controller 204 can further automatically add in new messages to evaluate and/or can replace poor performing messages with messages that have scored better and/or which are expected to score higher. In another example the tracking controller 204 can analyze the gaming activity vs other data collected such as time of day, recent wins, game speed, number of players at the table. The gaming system 100 can, for instance, determine that a certain game feature (e.g. side bets) are played more often when tables are full and play is slow. In response, the gaming system 100 can enable implementation of certain policies, such as policies that encourage tables to be full and/or that encourage dealers to deal more casually (if the increased hold on the side bets outweighs the decreased number of hands played). In one embodiment, the gaming system 100 generates and presents messages to the participants (players and/or dealer) that support the policies.

The messaging coordinator 214 presents the message(s) at an output device of the gaming table 101. For instance, the messaging coordinator 214 can present a message via a display 106, which is coupled to the gaming table 101. Other devices at the gaming table 101 can be used as output devices, such as a mobile device 173 associated with the individual 171. Other output devices include, but are not limited to, table signage (e.g., the CoolSign® digital signage network by Light & Wonder, Inc.), table sensors (e.g., to cause sensors/lights at bet zones to blink to generate feedback), speakers or other sound devices, haptic devices, emotive lighting devices, spot lights, projection devices (e.g., to project an indicator of a “hot seat” at the table, to project a highlight or other indicator of the locations of where bets can be placed, etc.), player interface devices (e.g., an iView® player-interface system by Light & Wonder, Inc.), mobile devices of players linked to a wired/wireless docking station, etc.

FIG. 2 is a diagram of an example gaming system 200 for tracking aspects of a wagering game in a gaming area 201 (also referred to as a “gaming environment”) according one or more embodiments of the present disclosure. In the example embodiment, the gaming system 200 includes a game controller 202, a tracking controller 204, a sensor system 206, a tracking database system 208, a messaging coordinator 214, an effectiveness evaluator 216, and a messaging database system 218. In other embodiments, the gaming system 200 may include additional, fewer, or alternative components, including those described elsewhere herein. For example, in one embodiment, the tracking controller 204, the messaging coordinator 214, and the effectiveness evaluator 216 can be included in one device or system. For example, in one embodiment the messaging coordinator 214 and the effectiveness evaluator 216 can be included as part of the tracking controller 204. In another example, in one embodiment the tracking database system 208 is separate from the messaging database system 218, whereas in a different embodiment, the tracking database system 208 is integrated with the messaging database system 218. In another embodiment, the tracking controller 204 pushes to the other systems and/or devices the gaming activity data that they require (e.g., pushes card presence data, betting data, card values, game outcome data, etc., to the messaging coordinator 214, the effectiveness evaluator 216, the external interface 212, etc.). In one embodiment, the gaming system 200 can push gaming activity data, messages, etc. to a table progressive system and/or any signage associated with the table progressive system.

The gaming area 201 is an environment in which one or more casino wagering games are provided. In the example embodiment, the gaming area 201 is a casino gaming table and the area surrounding the table (e.g., see FIG. 1). In other embodiments, other suitable gaming areas may be monitored by the gaming system 200. For example, the gaming area 201 may include one or more floor-standing electronic gaming machines. In another example, multiple gaming tables may be monitored by the gaming system 200. Although the description herein may reference a gaming area (such as gaming area 201) to be a single gaming table and the area surrounding the gaming table, it is to be understood that other gaming areas may be used with the gaming system 200 by employing the same, similar, and/or adapted details as described herein.

The game controller 202 is configured to facilitate, monitor, manage, and/or control gameplay of the one or more games at the gaming area 201. More specifically, the game controller 202 is communicatively coupled to at least one or more of the tracking controller 204, the sensor system 206, the tracking database system 208, the messaging coordinator 214, the effectiveness evaluator 216, the messaging database system 218, a gaming device 210, an external interface 212, and/or a server system 214 to receive, generate, and transmit data relating to the games, the players, and/or the gaming area 201. The game controller 202 may include one or more processors, memory devices, and communication devices to perform the functionality described herein. More specifically, the memory devices store computer-readable instructions that, when executed by the processors, cause the game controller 202 to function as described herein, including communicating with the devices of the gaming system 200 via the communication device(s).

The game controller 202 may be physically located at the gaming area 201 as shown in FIG. 2 or remotely located from the gaming area 201. In certain embodiments, the game controller 202 may be a distributed computing system. That is, several devices may operate together to provide the functionality of the game controller 202. In such embodiments, at least some of the devices (or their functionality) described in FIG. 2 may be incorporated within the distributed game controller 202.

The gaming device 210 is configured to facilitate one or more aspects of a game. For example, for card-based games, the gaming device 210 may be a card shuffler, shoe, or other card-handling device (e.g., card-handling device 105). The external interface 212 is a device that presents information to a player, dealer, or other user and may accept user input to be provided to the game controller 202. In some embodiments, the external interface 212 may be a remote computing device in communication with the game controller 202, such as a player's mobile device. In other examples, the gaming device 210 and/or external interface 212 includes one or more projectors. The server system 214 is configured to provide one or more backend services and/or gameplay services to the game controller 202. For example, the server system 214 may include accounting services to monitor wagers, payouts, and jackpots for the gaming area 201. In another example, the server system 214 is configured to control gameplay by sending gameplay instructions or outcomes to the game controller 202. It is to be understood that the devices described above in communication with the game controller 202 are for exemplary purposes only, and that additional, fewer, or alternative devices may communicate with the game controller 202, including those described elsewhere herein.

In the example embodiment, the tracking controller 204 is in communication with the game controller 202. In other embodiments, the tracking controller 204 is integrated with the game controller 202 such that the game controller 202 provides the functionality of the tracking controller 204 as described herein. Like the game controller 202, the tracking controller 204 may be a single device or a distributed computing system. In one example, the tracking controller 204 may be at least partially located remotely from the gaming area 201. That is, the tracking controller 204 may receive data from one or more devices located at the gaming area 201 (e.g., the game controller 202 and/or the sensor system 206), analyze the received data, and/or transmit data back based on the analysis.

In the example embodiment, the tracking controller 204, similar to the example game controller 202, includes one or more processors, a memory device, and at least one communication device. The memory device is configured to store computer-executable instructions that, when executed by the processor(s), cause the tracking controller 204 to perform the functionality of the tracking controller 204 described herein. The communication device is configured to communicate with external devices and systems using any suitable communication protocols to enable the tracking controller 204 to interact with the external devices and integrates the functionality of the tracking controller 204 with the functionality of the external devices. The tracking controller 204 may include several communication devices to facilitate communication with a variety of external devices using different communication protocols.

The tracking controller 204 is configured to monitor at least one or more aspects of the gaming area 201. In the example embodiment, the tracking controller 204 is configured to monitor physical objects within the area 201, and determine a relationship between one or more of the objects. Some objects may include gaming tokens. The tokens may be any physical object (or set of physical objects) used to place wagers. As used herein, the term “stack” refers to one or more gaming tokens physically grouped together. For circular tokens typically found in casino gaming environments (e.g., gaming chips), these may be grouped together into a vertical stack. In another example in which the tokens are monetary bills and coins, a group of bills and coins may be considered a “stack” based on the physical contact of the group with each other and other factors as described herein.

In the example embodiment, the tracking controller 204 is communicatively coupled to the sensor system 206 to monitor the gaming area 201. More specifically, the sensor system 206 includes one or more sensors configured to collect sensor data associated with the gaming area 201, and the tracking controller 204 receives and analyzes the collected sensor data to detect and monitor physical objects. The sensor system 206 may include any suitable number, type, and/or configuration of sensors to provide sensor data to the game controller 202, the tracking controller 204, and/or another device that may benefit from the sensor data.

In the example embodiment, the sensor system 206 includes at least one image sensor that is oriented to capture image data of physical objects in the gaming area 201. In one example, the sensor system 206 may include a single image sensor that monitors the gaming area 201. In another example, the sensor system 206 includes a plurality of image sensors (e.g., camera 102 and camera 103) that monitor subdivisions of the gaming area 201. The image sensor may be part of a camera unit of the sensor system 206 or a three-dimensional (3D) camera unit in which the image sensor, in combination with other image sensors and/or other types of sensors, may collect depth data related to the image data, which may be used to distinguish between objects within the image data. The image data is transmitted to the tracking controller 204 for analysis as described herein. In some embodiments, the image sensor is configured to transmit the image data with limited image processing or analysis such that the tracking controller 204 and/or another device receiving the image data performs the image processing and analysis. In other embodiments, the image sensor (or a dedicated computing device of the image sensor) may perform at least some preliminary image processing and/or analysis prior to transmitting the image data. In such embodiments, the image sensor may be considered an extension of the tracking controller 204, and as such, functionality described herein related to image processing and analysis that is performed by the tracking controller 204 may be performed by the image sensor (or a dedicated computing device of the image sensor). In certain embodiments, the sensor system 206 may include, in addition to or instead of the image sensor, one or more sensors configured to detect objects, such as time-of-flight sensors, radar sensors (e.g., LIDAR), thermographic sensors, and the like. Furthermore, in some embodiments, the image sensors capture images with a high level of image resolution (e.g., 4K resolution cameras) resulting in image files that are large compared to an input requirement of a machine learning model. For example, in at least one embodiment, the tracking controller 204 communicates with (e.g., is subscribed to) a cloud-service on which one or more of the machine learning models are hosted and maintained. Thus in some embodiments, the tracking controller 204 (and/or the sensor system 206) can perform image processing to the high-resolution images prior to transmitting the image data to the cloud service, such as by cropping portions of the high-resolution images and compositing them into a single image file as described in U.S. patent application Ser. No. 17/217,090 filed Mar. 30, 2020, which is hereby incorporated by reference in its entirety. In other embodiments, the tracking controller 204 is connected to a local device (e.g., an edge computing device) at the gaming table 101 configured to store and execute one or more of the machine learning models.

The tracking controller 204 is configured to establish data structures relating to various physical objects detected in the image data from the image sensor. For example, the tracking controller 204 applies one or more image neural network models during image analysis that are trained to detect aspects of physical objects. Neural network models are analysis tools that classify “raw” or unclassified input data without requiring user input. That is, in the case of the raw image data captured by the image sensor, the neural network models may be used to translate patterns within the image data to data object representations of, for example, tokens, faces, hands, etc., thereby facilitating data storage and analysis of objects detected in the image data as described herein.

At a simplified level, neural network models are a set of node functions that have a respective weight applied to each function. The node functions and the respective weights are configured to receive some form of raw input data (e.g., image data), establish patterns within the raw input data, and generate outputs based on the established patterns. The weights are applied to the node functions to facilitate refinement of the model to recognize certain patterns (i.e., increased weight is given to node functions resulting in correct outputs), and/or to adapt to new patterns. For example, a neural network model may be configured to receive input data, detect patterns in the image data representing human body parts, perform image segmentation, and generate an output that classifies one or more portions of the image data as representative of segments of a player's body parts (e.g., a box having coordinates relative to the image data that encapsulates a face, an arm, a hand, etc. and classifies the encapsulated area as a “human,” “face,” “arm,” “hand,” etc.).

For instance, to train a neural network to identify the most relevant guesses for identifying a human body part, for example, a predetermined dataset of raw image data including image data of human body parts, and with known outputs, is provided to the neural network. As each node function is applied to the raw input of a known output, an error correction analysis is performed such that node functions that result in outputs near or matching the known output may be given an increased weight while node functions having a significant error may be given a decreased weight. In the example of identifying a human face, node functions that consistently recognize image patterns of facial features (e.g., nose, eyes, mouth, etc.) may be given additional weight. Similarly, in the example of identifying a human hand, node functions that consistently recognize image patterns of hand features (e.g., wrist, fingers, palm, etc.) may be given additional weight. The outputs of the node functions (including the respective weights) are then evaluated in combination to provide an output such as a data structure representing a human face. Training may be repeated to further refine the pattern-recognition of the model, and the model may still be refined during deployment (i.e., raw input without a known data output).

In another example, to train a neural network to identify the most relevant guesses for identifying a card value, for example, a predetermined dataset of raw image data including image data of playing cards, and with known outputs, is provided to the neural network. As each node function is applied to the raw input of a known output, an error correction analysis is performed such that node functions that result in outputs near or matching the known output may be given an increased weight while node functions having a significant error may be given a decreased weight. In the example of identifying a card value, node functions that consistently recognize image patterns of card features (e.g., card proportions, card shape, card edges, etc.) may be given additional weight. Similarly, in the example of identifying a specific rank or suit, node functions that consistently recognize image patterns of symbols or symbol features (e.g., number values, suit shapes, symbol placement, etc.) may be given additional weight. The outputs of the node functions (including the respective weights) are then evaluated in combination to provide an output such as a data structure representing a value of a playing card. Training may be repeated to further refine the pattern-recognition of the model, and the model may still be refined during deployment (i.e., raw input without a known data output).

At least some of the neural network models applied by the tracking controller 204 may be deep neural network (DNN) models. DNN models include at least three layers of node functions linked together to break the complexity of image analysis into a series of steps of increasing abstraction from the original image data. For example, for a DNN model trained to detect playing cards from an image, a first layer may be trained to identify groups of pixels that represent the boundary of card features, a second layer may be trained to identify the card features as a whole based on the identified boundaries, and a third layer may be trained to determine whether or not the identified card features include a suit and rank that distinguish the playing card value from other playing card values. The multi-layered nature of the DNN models may facilitate more targeted weights, a reduced number of node functions, and/or pipeline processing of the image data (e.g., for a three-layered DNN model, each stage of the model may process three frames of image data in parallel).

In at least some embodiments, each model applied by the tracking controller 204 may be configured to identify a particular aspect of the image data and provide different outputs such that the tracking controller 204 may aggregate the outputs of the neural network models together to identify physical objects as described herein. For example, one model may be trained to identify card placement at a table, while another model may be trained to identify the values of the cards. In such an example, the tracking controller 204 may link together a card hand at a player station to an overall value of the card hand (i.e., playing card values) by analyzing the outputs of the two models. In other embodiments, a single DNN model may be applied to perform the functionality of several models.

As described in further detail below, the tracking controller 204 may generate data objects for each physical object identified within the captured image data by the DNN models. The data objects are data structures that are generated to link together data associated with corresponding physical objects. For example, the outputs of several DNN models associated with a player may be linked together as part of a player data object.

It is to be understood that the underlying data storage of the data objects may vary in accordance with the computing environment of the memory device or devices that store the data object. That is, factors such as programming language and file system may vary the where and/or how the data object is stored (e.g., via a single block allocation of data storage, via distributed storage with pointers linking the data together, etc.). In addition, some data objects may be stored across several different memory devices or databases.

In some embodiments, the player data objects include a player identifier, and data objects of other physical objects include other identifiers. The identifiers uniquely identify the physical objects such that the data stored within the data objects is tied to the physical objects. In some embodiments, the identifiers may be incorporated into other systems or subsystems. For example, a player account system may store player identifiers as part of player accounts, which may be used to provide benefits, rewards, and the like to players. In certain embodiments, the identifiers may be provided to the tracking controller 204 by other systems that may have already generated the identifiers.

In at least some embodiments, the data objects and identifiers may be stored by the tracking database system 208. The tracking database system 208 includes one or more data storage devices (e.g., one or more databases) that store data from at least the tracking controller 204 in a structured, addressable manner. That is, the tracking database system 208 stores data according to one or more linked metadata fields that identify the type of data stored and can be used to group stored data together across several metadata fields. The stored data is addressable such that stored data within the tracking database system 208 may be tracked after initial storage for retrieval, deletion, and/or subsequent data manipulation (e.g., editing or moving the data). The tracking database system 208 may be formatted according to one or more suitable file system structures (e.g., FAT, exFAT, ext4, NTFS, etc.).

The tracking database system 208 may be a distributed system (i.e., the data storage devices are distributed to a plurality of computing devices) or a single device system. In certain embodiments, the tracking database system 208 may be integrated with one or more computing devices configured to provide other functionality to the gaming system 200 and/or other gaming systems. For example, the tracking database system 208 may be integrated with the tracking controller 204 or the server system 214.

In the example embodiment, the tracking database system 208 is configured to facilitate a lookup function on the stored data for the tracking controller 204. The lookup function compares input data provided by the tracking controller 204 to the data stored within the tracking database system 208 to identify any “matching” data. It is to be understood that “matching” within the context of the lookup function may refer to the input data being the same, substantially similar, or linked to stored data in the tracking database system 208. For example, if the input data is an image of a player's face, the lookup function may be performed to compare the input data to a set of stored images of historical players to determine whether or not the player captured in the input data is a returning player. In this example, one or more image comparison techniques may be used to identify any “matching” image stored by the tracking database system 208. For example, key visual markers for distinguishing the player may be extracted from the input data and compared to similar key visual markers of the stored data. If the same or substantially similar visual markers are found within the tracking database system 208, the matching stored image may be retrieved. In addition to or instead of the matching image, other data linked to the matching stored image may be retrieved during the lookup function, such as a player account number, the player's name, etc. In at least some embodiments, the tracking database system 208 includes at least one computing device that is configured to perform the lookup function. In other embodiments, the lookup function is performed by a device in communication with the tracking database system 208 (e.g., the tracking controller 204) or a device in which the tracking database system 208 is integrated within.

In some embodiments, the messaging coordinator 214 is configured to generate and coordinate the presentation of one or more messages (e.g., according to a schedule, based on one or more statistical correlations to gaming activity that is detected by the tracking controller 204, etc.). In some embodiments, the messaging coordinator 214 is configured to communicate with an output device via the external interface 212 (e.g., either directly or via the tracking controller 204) to present the message(s). The effectiveness evaluator 216 is configured to generate effectiveness scores for message(s) based on comparison of a time and date of gaming-activity events that occurred to the time and date of the message(s) (and/or to other gaming activity that occurs after the presentation of certain message(s)). In some embodiments, the messaging coordinator 214 and the effectiveness evaluator 216 store, in the messaging database system 218 (e.g., in table 710), references or links to gaming activity data stored in the tracking database system 208 (e.g., from table 730). The messaging coordinator 214 also stores (e.g., in table 710) messaging data generated by the messaging coordinator 214. In some embodiments, the tracking controller 204 can further store (e.g., in a report, in a database table, etc.) effectiveness data generated by the effectiveness evaluator 216.

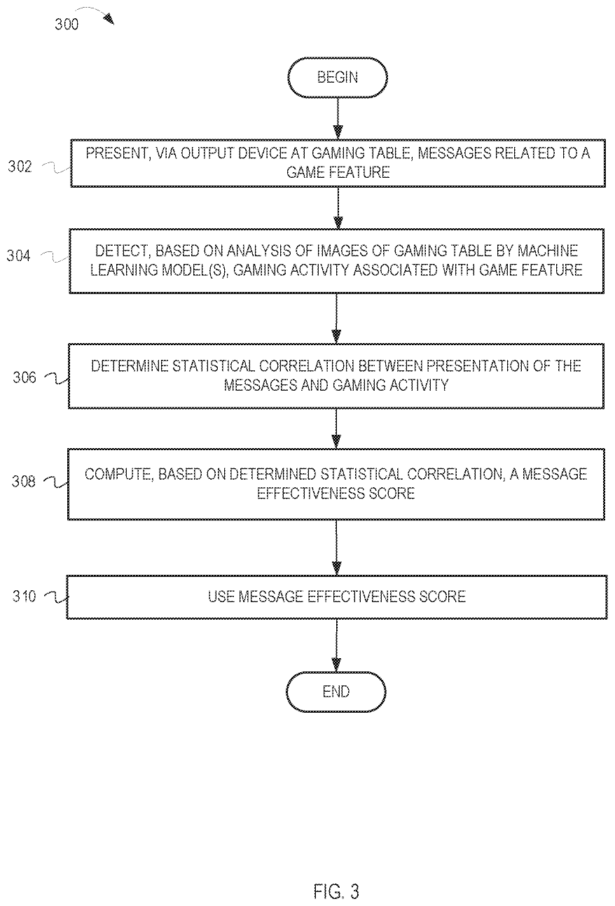

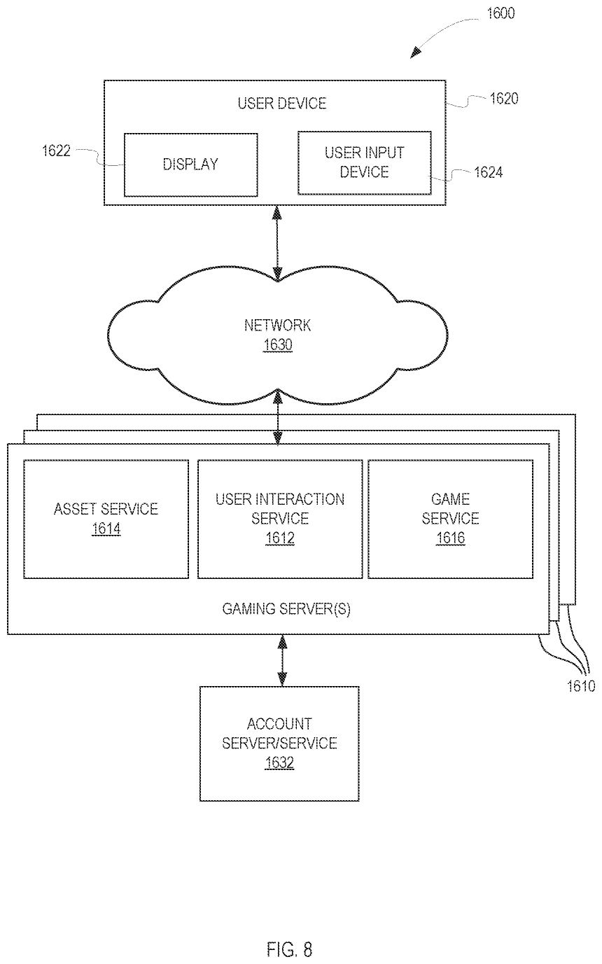

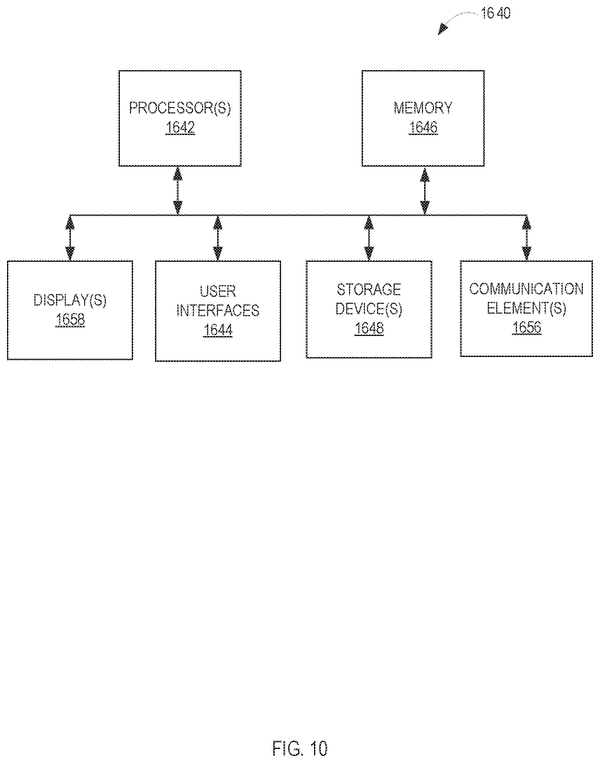

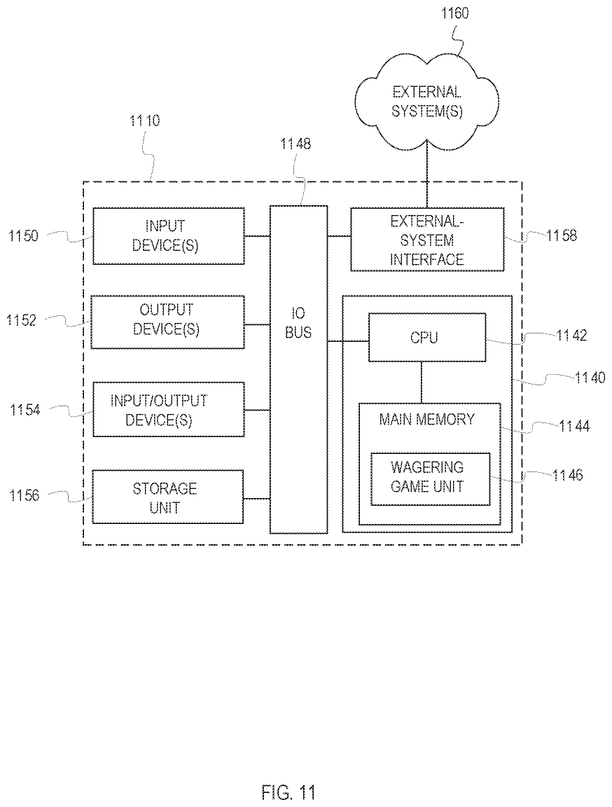

FIG. 3 is a flow diagram of a flow 300 illustrating an example method according to one or more embodiments of the present disclosure. The flow 300 refers to a processor. It should be noted that the reference to the processor may refer to the same physical processor or it may be one of a set of a plurality of processors. The set of processors may operate in conjunction with each other and may be distributed across various networked devices (e.g., across the gaming system 100). The types of processors may include a central processing unit, a graphics processing unit, any combination of processors, etc. In one embodiment, the processor may be included in, or refer to, to any one of the tracking controller 204, the messaging coordinator 214, the effectiveness evaluator 216, the sensor system 206, the game controller 202, or the game device 210 (see FIG. 2). In one embodiment, the processor may be included in, or refer to, the user device 1620, the gaming server(s) 1610, or the account server/service 1632 (see FIG. 8). In one embodiment, the processor may be included in, or refer to, the table 1682 (or any device thereof, such as the camera 1670, the projector 1671, the dealer terminal 1688, the player action indicator 1690, the card handling system 1684, the table manager terminal 1686, or the user device 1620 (see FIG. 9)). In one embodiment, the processor may be the processor(s) 1642 (see FIG. 10). In another embodiment, the processor is the central processing unit (CPU) 1142 (see FIG. 11) or a processor in another device mentioned herein, such as a processor associated with a table controller, a card-handling device, a camera controller, a game controller, a gaming server etc.

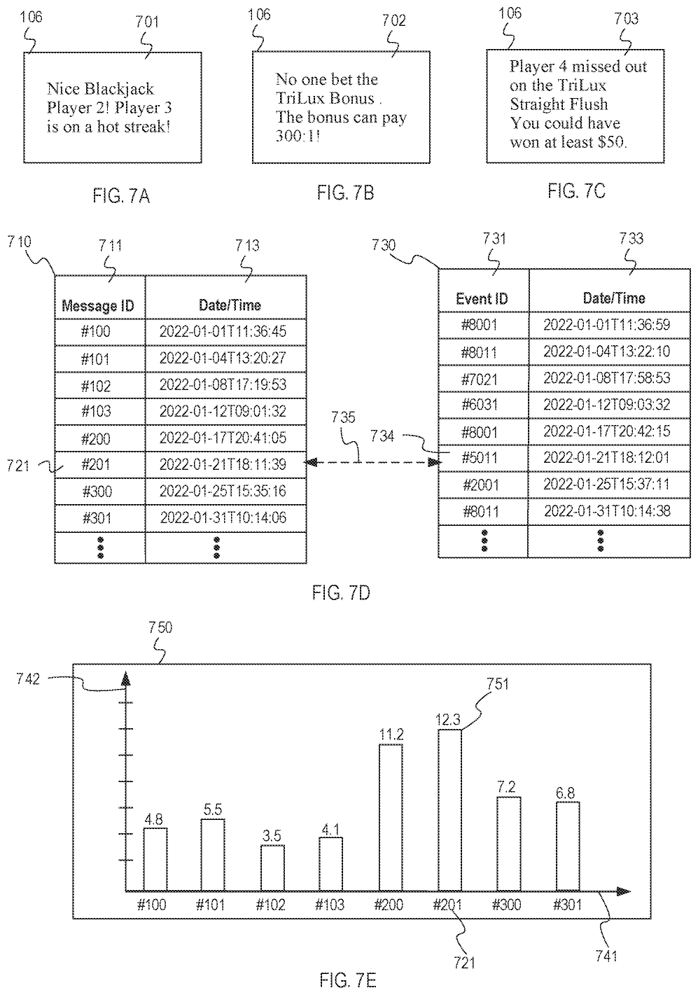

In FIG. 3, the flow 300 begins at processing block 302, where a processor presents, via an output device at a gaming table, messages related to a game feature. Messages related to a game feature may be referred to herein as “feature-related” messages. The processor presents the feature-related messages during an evaluation period, or rather, an amount of time required to gather enough data (pertaining to instances of presentation for messages as well as instances of occurrence of gaming activity events) to detect a statistical correlation between the timing of the message presentation and the timing of occurrence of the gaming activity. For example, the evaluation period may be several weeks, a month, several months, etc. depending a desired report range. In some embodiments, the processor stores (e.g., in a first table of a database) message identifiers and message presentation times (e.g., see table 710 in FIG. 7D).

Still referring to FIG. 3, the flow 300 continues at processing block 304, where a processor detects, based on analysis of images of the gaming table by one or more machine learning model(s), gaming activity associated with the game feature. The processor detects the gaming activity that occurs over the evaluation period. The processor stores, in a second table (e.g., see table 730 in FIG. 7D), information such as a gaming activity/event identifier, gaming activity detected time, detected player data (also detectable by a machine learning model, such as player position at table), detected outcome data (e.g., win/loss), etc. Furthermore, the processor tracks gaming activity timing and message presentation timing using either the same clock or according to a synchronized system clock so that statistical timing correlations are accurate.

Referring again to FIG. 3, the flow 300 continues at processing block 306, where a processor determines a statistical correlation between the presentation of the messages and the gaming activity. In one embodiment, the processor determines the statistical correlation by comparing message data to gaming activity data. For example the processor compares a time of presentation of a feature-related message to a time of an occurrence of a feature-related gaming-activity event (also referred to as a “gaming event” or an “event”) to determine whether the gaming event occurred within a specific “response period” after the message. More specifically, the response period is an estimated amount of time, after the message is presented, during which a message can be seen, read, and responded to (i.e., “response period”), or in other words a period of time, after the message is presented, during which the message reasonably could have been seen by an individual (e.g., the player, a side-better, any game participant, a potential game participant, a patron, the dealer, etc.) and thus could have influenced the individual to perform the feature-related gaming activity mentioned in the message. The response period can include a range of time selected by the operator. The range includes a low-end time that the operator considers that an individual (e.g. an average player) would have read the message and performed the gaming-activity event mentioned in the message. The range also includes a high-end time that represents either the amount of time that the message is displayed, or the most amount of time that the operator considers that the message should have been read and responded to. For instance, one example range for the response period can be somewhere between ten seconds (at the low end) to about two minutes (at the high end). Thus, if a gaming event occurred within the response period from the message-presentation time, the processor determines that the appearance of the message was influential to the occurrence of the gaming event, thus statistically correlated to the gaming event.

In one embodiment, the processor compares a time stamp for a message to a time stamp of the gaming event. Based on the comparison, the processor determines whether the gaming-event time occurred within the response period after the message was presented. If the gaming-event occurred within the response period, the processor records a statistical timing correlation between the timing of the message and the timing of the gaming event.

Referring still to FIG. 3, the flow 300 continues at processing block 308, where a processor computes, based on the determined statistical correlation, a message effectiveness score. In one embodiment, the processor can increase a message effectiveness score based on a number of statistical correlations to the messages as well as based on an amount/level of increase to gaming activity. Furthermore, in some embodiments, the processor can detect a lack of gaming activity for a game feature (e.g., one or more machine-learning models detect none or very little activity for the game feature). The processor can further generate, select, and/or present messages in response to detection of the lack of gaming activity. The processor can further detect whether an increase occurs to the gaming activity (e.g., from one betting level to another betting level) after presentation of a message. In response to detecting the increase in gaming activity, the processor can modify a message effectiveness score based on (e.g., proportional to) the increase in the gaming activity.

Referring again to FIG. 3, the flow 300 continues at processing block 310, where a processor uses the message effectiveness score. For example, the processor can present the message effectiveness score in a report. In another example, the processor can generate feedback messages based on message effectiveness scores.

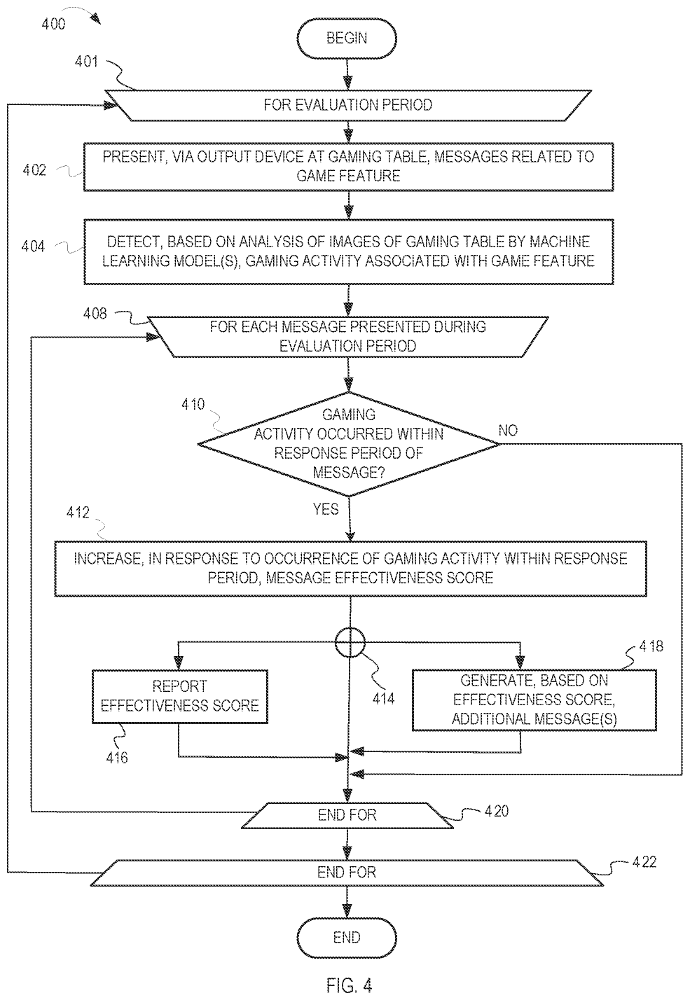

FIG. 4 is a flow diagram of flow 400 illustrating an example method according to one or more embodiments of the present disclosure. FIGS. 5A, 5B, 6, 7A, 7B, 7C, 7D, and 7E are diagrams of an exemplary gaming system associated with the data flow 400 shown in FIG. 4 according to one or more embodiments of the present disclosure. FIGS. 5A, 5B, 6, 7A, 7B, 7C, 7D, and 7E will be referenced in the description of FIG. 4. Furthermore, the flow 400 may refer to a processor (as similarly described for flow 300).

In FIG. 4, the flow 400 begins at processing block 401 where a processor initiates a first loop for an evaluation period. In some embodiments, the first loop continues until loop parameters are accomplished (at processing block 422). For example, the first loop is for a period of time in which to run (i.e., evaluate) the messages. In another example, the processor selects data from a database that collects, over time, data for the presentation of messages and for the occurrence of gaming events. In some embodiments, the processor uses the evaluation period as a filter or search space parameter.

The flow 400 continues at processing block 402, where a processor presents (e.g., animates), via an output device at a gaming table, messages related to a game feature, similarly as described in flow 300 at processing block 302. Furthermore, the flow 400 continues at processing block 404, where a processor detects, based on analysis of images of the gaming table by one or more machine learning models, gaming activity associated with the game feature. In one embodiment one of the machine learning models (e.g., first machine learning model) detects playing activity via analysis of first images of the gaming table. For instance the first machine learning model (ML1) detects card placement at participant stations depicted in the first images (e.g., see FIG. 1). Thus, the processor can determine, by ML1 via detection of the cards at the participant stations, playing activity for the one or more participant stations. The processor further stores in a memory (e.g., in tracking database system 208, in messaging database system 218, in table 730, etc.) gaming activity data for the one or more participant stations, such as indicators of the card placement for each of the one or more participant stations. In some embodiments, the processor analyzes, via ML1, a position of the card placement at the table, a number of cards dealt per card distribution rules of the game (e.g., to detect a state of a wagering game), a quality or quantity of cards played or requested, a number of hands played, etc. In some embodiments, the processor detects playing activity by detecting signal(s) from sensors at card placement zones (e.g., detecting an RFID signal in playing cards or detecting weight sensors that detect a weight of playing cards within a card placement zone), by detecting LIDAR signals of cards, by detecting a combination of sensor signals, etc.)

In one example, as shown in FIG. 5A, a processor (e.g., the tracking controller 204) draws (e.g., animates) a virtual overlay to the image 501 based on dimensions of a frame of an image or video feed of the gaming table 101. For instance, the tracking controller 204 detects, and draws on the virtual overlay, a centroid 511 of one or more of the cards 146 and 147 and also detects other objects on the table, such as all of the bet spots on the table (including the bet spots 121, 122, 142, and 141). The tracking controller 204 also detects the centroids 510 of the bet spots (i.e., center points for each of the bet spots). The tracking controller 204 draws the centroids 510 for each of the bet spots. In one example, the tracking controller 204 further detects the distances between the centroids of the cards and the centroids of the detected bet spots. For example, the tracking controller 204 draws lines 502, 503, 504, and 505 between the centroid 511 and the centroids 510 for each of the closest bet spots in the image 501. The tracking controller 204 can match up a centroid for a card to a centroid for a particular bet spot based on the minimum distance between centroids. For example, the tracking controller 204 can measure the lengths of the lines 502, 503, 504, and 505 and select the line of shortest length (e.g. line 503). The tracking controller 204 then associates the cards 146 and 147 to the betting spot 142 based on its proximity being closest (i.e., based the line 503 being the shortest of the drawn lines 502, 503, 504, and 505). The tracking controller 204 can also perform a similar measurement of distances between the centroids of cards 126 and 127 and the centroids of the nearest bet spots to ascertain the participant station to which the cards 126 and 127 were dealt. In some embodiments, prior to drawing the lines 502, 503, 504, and 505, the tracking controller 204 performs, via the virtual overlay, a translation or transformation of the image 501 to translate or transform the geometry of the image from a sideways perspective to an overhead perspective (e.g., transforms the appearance of image 501 and/or 550 such that the betting spots appear as circles on the virtual overlay as opposed to stretched out ellipses).

In one embodiment a machine learning model (e.g., second machine learning model) detects betting activity (including betting levels) via analysis of either the first image(s) of the gaming table (if the first images were captured before bets are placed) or via analysis of second image(s) captured after all bets have been placed for the wagering game. For instance, as illustrated in FIGS. 5A and 56, after all bets are placed, two cameras (e.g., camera 102 and camera 103) capture images 501 and 550 of the gaming table 101 from different angles. For example, image 501 (captured via camera 103) depicts the fourth participant station 140 in the foreground of the image 501, including the bet spots 141, 142, the chip 144, and the playing cards 146, 147. The image 501 also depicts the second participant station 120 in the background of the image 501, including the bet spots 121, 122, the chip 125, the chip stack 124, and the playing cards 126, 127. The image 550 (captured via camera 102) depicts the second participant station 120 in the foreground of the image 550, and the fourth participant station 140 in the background of the image 550. The tracking controller 204, for instance, uses a machine learning model (e.g., ML2) to detect, via analysis of the images 501 and 550, chip placement on bet zones at the participant stations. The processor can further determine (e.g., via ML2) betting values. For example, ML2 detects values of individual chips or values of chip stacks placed within bet zones (e.g., see U.S. patent application Ser. No. 17/319,841 mentioned previously).

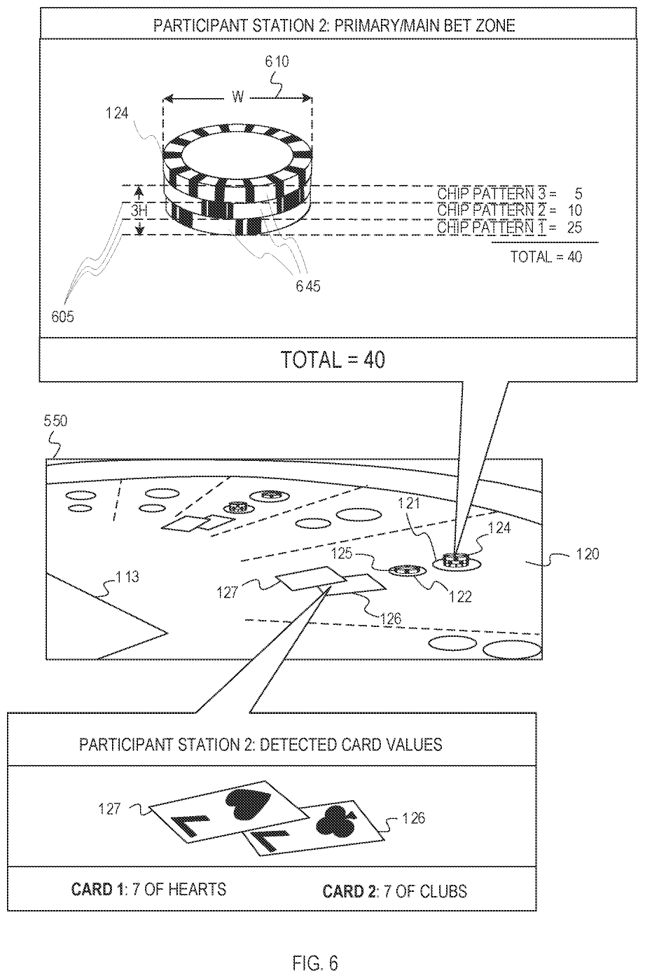

In some embodiments, as illustrated in FIG. 6, the processor determines (e.g., via ML2) betting amounts and other betting statistics or data per bet zone at the participant station. In FIG. 6, the processor determines (e.g., via ML2), that the chip stack 124 includes three standard sized chips stacked upon each other. The processor further accesses known geometric data for a chip, such as known relative chip dimensions (e.g., height 605 and width 610) of a standard-sized, model chip as viewed from at least one of a plurality of perspectives on which a machine-learning model is trained (e.g., trained on a side view of chips, such as from the general perspective of the camera(s) 102 and/or 103). Based on the known dimensions, the processor can determine (e.g., via ML2) the precise locations and dimensions of chip-edge patterns 645 printed on the outer edges of the chips in the chip stack 124. The machine learning model (e.g., ML2) is trained on images of chips (e.g., from a perspective of a camera view) to detect chip information, such as chip dimensions, text on chip faces, chip-face colors, chip-edge patterns (dimensions and/or colors of chip edges), etc., to detect chip values associated with the chips. In FIG. 6, the processor determines, based on the chip information (including the chip colors, chip-edge patterns 645, etc.) that the chip stack 124 has a total value of forty dollars ($40 USD). The processor stores the betting activity (e.g., the $40 chip stack value) in association with the primary bet zone (e.g., in association with the main bet spot 121). The processor can further determine (e.g., via ML2) the value of the chip 125 in the secondary bet zone (e.g., in the secondary bet spot 122) and store the value of the chip 125 in association with the secondary bet zone.

In some embodiments, the processor detects signal(s) from sensors at bet zones (e.g., detecting an RFID signal in chips, detecting weight sensors that detect a weight of chip stacks within a bet zone, detecting LIDAR signals of chip stacks, detecting a combination of sensor signals, etc.). The processor can use the signals to determine betting activity.

Still referring to FIG. 6, the processor detects card values, such as the card values for cards 127 and 126. The processor can utilize a machine learning model (e.g., third machine learning model). The third machine learning model (ML3) is trained on images of standard playing cards taken from the general perspective of images sensors (e.g., trained according to the perspective of camera(s) 102 and/or 103, trained according to a viewing perspective of a camera in a card-handling device, etc.). ML3 can crop and transform (e.g., rotate, tilt, resize, etc.) images of the cards 126 and 127 to detect symbol features (e.g., orientation of symbols, shapes of symbols, etc.) on the cards 126 and 127, which symbol features are associated with the rank and suit of the cards. ML3, for instance, determines, based on the detected symbol features, the ranks and suits of the cards and combines the detected card values into a hand. The processor then compares the card hand to game rules or other game outcome criteria (e.g., outcome criteria comprises a listing of winning and/or losing card hands based on rules of the game played at the gaming table 101).

In some embodiments the flow 400 includes detecting, via the one or more machine learning models, a lack of gaming activity associated with a certain game feature (e.g., detects no placement of bonus bets or side bets). In response to the detection of the lack of the gaming activity, the processor can generate a message related to the game feature. Furthermore, the processor can present the message via an output device at gaming table. In one embodiment, the message refers to at least one aspect of the gaming activity, such as playing activity, betting activity, game outcomes, etc. Furthermore, in some embodiments, the message refers to the gaming activity in reference to one or more game features, such as the game feature tracked via the gaming activity (and/or tracked via lack of gaming activity), or another (second) game feature that is related to the first game feature.

In some embodiments, the processor generates message(s) based on game outcome data for each participant station and/or based on betting data for each participant station. In some embodiments, the message mentions statistics from either the game outcome data or from the betting data, as well as any related participant station data. In some embodiments, the statistics are related to different types of messages, including, but not limited to: celebrations, enticements, condolences, etc. For instance, as shown in FIG. 7A, the processor presents (e.g., via display 106) a celebratory message 701 that refers to winning game outcome data for participant stations (e.g., “Nice Blackjack Player 2! Player 3 is on a hot streak!”). The winning outcome data refers to winning outcome data placed on main bets in a Blackjack game. In another example, as shown in FIG. 7B, the processor presents (e.g., via display 106) an enticement message 702 that refers to detection of betting activity (or detection of non-betting activity) for one or more game features at one or more participant stations (e.g., “No one bet the TriLux Bonus O”) and also refers to enticement data (e.g., “The bonus can pay 300:1!”). The betting activity and/or enticement data refers to betting data for a secondary betting feature (e.g., the “TriLux Bonus”). In yet another example, as shown in FIG. 7C, the processor presents (e.g., via display 106) a condolences message 703 that refers to losing game outcome data or near miss game outcome data for participant station(s) (e.g., “Player 4 missed out on the TriLux Straight Flush O”) as well as enticement data (e.g., “You could have won at least $50”).

In one embodiment, the processor stores message data and gaming activity data for subsequent evaluation. For example, in FIG. 7D the processor stores a history of messages in a data table (e.g., table 710). The table 710 includes a column for a message identifier 711 (e.g., an identifier that specifies a specific type of message), a device identifier (e.g., an identifier for a device at which the message was presented), a date/time stamp 713 (e.g., the data and/or time at which the message was presented), etc. Furthermore, in FIG. 7D the processor stores a history of gaming activity in a data table (i.e., table 730). The table 730 includes a column for an event identifier 731 (which describes the type of event that occurred), a date/time stamp 733, etc. In some embodiments, the table 730 can include multiple descriptive tags or secondary identifiers that specify a variety of different types of game-related events or player-related information, such as participant station information, player identity, player rating data, betting tied to a particular location or person, betting amounts, game outcome data, etc.

Referring back to FIG. 4, the flow 400 continues at processing block 408, where the processor initiates a second loop. In some embodiments, the second loop continues until loop parameters are accomplished (at processing block 420). For example, the second loop evaluates each feature-related message presented during the evaluation period. At processing block 410, the processor determines whether a feature-related gaming event occurred within the aforementioned response period (e.g., within the ten-second to two-minute response period after the time stamp for the feature-related message). If, at processing block 410, the processor does not detect that a feature-related gaming event occurred within the response period after the message, then the second loop continues to processing block 420 (e.g., returns to processing block 408 to evaluate the next sequential message for the second loop). If, however, at processing block 410, the processor determines that a feature-related gaming event occurred within the response period, then the flow 400 continues at processing block 412 where the processor increases, in response to occurrence of the feature-related gaming event, a message effectiveness score. For instance, in FIG. 7D the processor evaluates events according to a response period range of greater than ten seconds at the low end of the range and less than two minutes at the high end of the range. During evaluation, the processor detects that message 721 (i.e., message ID “#201”) was presented on Jan. 21, 2022 at “18:11:39” (at about 6:11 PM). The processor also detects that event 734 (i.e., event ID “#5011”) occurred on Jan. 21, 2022 at “18:12:01” (at about 6:12 PM). Thus, event 734 occurred within about a minute after message 721 was presented, which falls within the response period. Thus, the processor marks a statistical timing correlation 735 between the message 721 and the event 734. Each time that the processor detects that a feature-related gaming event occurs within the response period of a feature-related message, then the processor increases a message effectiveness score for that particular message (e.g., for that particular message identifier or message type(s)). The increase to the message effectiveness score is thus statistically correlated to the timing of the appearance of the message that caused, or influenced, the occurrence of the gaming event (e.g., influenced a bet or and increase to a bet on the related game feature). In some embodiments, the processor can (in addition to detecting an occurrence of a gaming event within a specific time period) detect a specificity of a value of the gaming event to determine an effectiveness of the message. For example, the processor can detect, via the one or more machine learning models, a difference between first gaming activity compared to the second (subsequently occurring) gaming activity. For instance, the processor can detect a difference in betting amounts over the evaluation period, such as to detect an increase or decrease in betting levels for the related game feature. The processor can further compute a message effectiveness score based on the detected difference, such as by computing a percentage increase or decrease in the betting levels for the game feature mentioned in the message and using the percentage increase/decrease as the message effectiveness score or as a factor for computing the message effectiveness score. For example, the processor can compute, as the message effectiveness score, a percentage increase of the betting levels for a given game feature (e.g., a secondary-bet feature or side-bet feature).

Referring back to FIG. 4, the flow 400 continues at processing block 414, where the processor uses the effectiveness score, such as to branch and perform either processing block 416 or processing block 418. At processing block 416, the processor reports the message effectiveness score. For instance, in FIG. 7E, the processor generates a report 750 that indicates (e.g., presents, animates, etc.) the message effectiveness score in relation to each message identifier stored in the data table 710 for the evaluation period. Displayed on a first axis 741 of the report 750 (e.g., on the “X” axis) are message IDs of messages as presented chronologically. On a second axis 742 (e.g., on the “Y” axis) are the percentage increase of side bets trailing the presentation of the message ID's (e.g., the percentage of sides bets increased by the amount 751 (i.e., 12.3%) in the near-term after message 721 was displayed). The report 740 displays the effectiveness of the messages in driving (e.g., increasing) the side-bets. Driving side-bets is only one example of reporting a message effectiveness score. The system can determine, and report the effectiveness on specific messaging on increases to main bets, or any other types of bets, betting activity, gaming activity, etc.

Referring back to the flow 400, at processing block 418 the processor generates, based on the message effectiveness score, one or more additional messages. For example, the processor can generate, based on the message effectiveness score, an additional message(s) related to the game feature. For instance, the processor can detect, based on the details of a report, a drop in effectiveness of a message. In response to detecting the drop in effectiveness, the processor can change the message presented at the table to a different message. The processor can detect, during an additional evaluation period after presentation of the additional message, additional (e.g., third) gaming activity associated with the game feature. The processor can detect the third gaming activity as similarly described for detecting the aforementioned first or second gaming activity, such as via ML1, ML2, and/or ML3. The processor further determines, based on comparison of the third gaming activity to the timing of the additional messages (and/or based on comparison of the third gaming activity to previously detected gaming activity) an effectiveness score of the additional message(s) in relation to the game feature.

In some embodiments, wagering games in accordance with this disclosure may be administered using a gaming system employing a client-server architecture (e.g., over the Internet, a local area network, etc.). FIG. 8 is a diagram of an illustrative gaming system 1600 for implementing wagering games in accordance with one or more embodiments of the present disclosure. The gaming system 1600 may enable end users to remotely access game content. Such game content may include, without limitation, various types of wagering games such as card games, dice games, big wheel games, roulette, scratch off games (“scratchers”), and any other wagering game where the game outcome is determined, in whole or in part, by one or more random events. This includes, but is not limited to, Class II and Class III games as defined under 25 U.S.C. § 2701 et seq. (“Indian Gaming Regulatory Act”). Such games may include banked and/or non-banked games.

The wagering games supported by the gaming system 1600 may be operated with real currency or with virtual credits or other virtual (e.g., electronic) value indicia. For example, the real currency option may be used with traditional casino and lottery-type wagering games in which money or other items of value are wagered and may be cashed out at the end of a game session. The virtual credits option may be used with wagering games in which credits (or other symbols) may be issued to a player to be used for the wagers. A player may be credited with credits in any way allowed, including, but not limited to, a player purchasing credits; being awarded credits as part of a contest or a win event in this or another game (including non-wagering games); being awarded credits as a reward for use of a product, casino, or other enterprise, time played in one session, or games played; or may be as simple as being awarded virtual credits upon logging in at a particular time or with a particular frequency, etc. Although credits may be won or lost, the ability of the player to cash out credits may be controlled or prevented. In one example, credits acquired (e.g., purchased or awarded) for use in a play-for-fun game may be limited to non-monetary redemption items, awards, or credits usable in the future or for another game or gaming session. The same credit redemption restrictions may be applied to some or all of credits won in a wagering game as well.

An additional variation includes web-based sites having both play-for-fun and wagering games, including issuance of free (non-monetary) credits usable to play the play-for-fun games. This feature may attract players to the site and to the games before they engage in wagering. In some embodiments, a limited number of free or promotional credits may be issued to entice players to play the games. Another method of issuing credits includes issuing free credits in exchange for identifying friends who may want to play. In another embodiment, additional credits may be issued after a period of time has elapsed to encourage the player to resume playing the game. The gaming system 1600 may enable players to buy additional game credits to allow the player to resume play. Objects of value may be awarded to play-for-fun players, which may or may not be in a direct exchange for credits. For example, a prize may be awarded or won for a highest scoring play-for-fun player during a defined time interval. All variations of credit redemption are contemplated, as desired by game designers and game hosts (the person or entity controlling the hosting systems).

The gaming system 1600 may include a gaming platform to establish a portal for an end user to access a wagering game hosted by one or more gaming servers 1610 over a network 1630. In some embodiments, games are accessed through a user interaction service 1612. The gaming system 1600 enables players to interact with a user device 1620 through a user input device 1624 and a display 1622 and to communicate with one or more gaming servers 1610 using a network 1630 (e.g., the Internet). Typically, the user device is remote from the gaming server 1610 and the network is the world-wide web (i.e., the Internet).

In some embodiments, the gaming servers 1610 may be configured as a single server to administer wagering games in combination with the user device 1620. In other embodiments, the gaming servers 1610 may be configured as separate servers for performing separate, dedicated functions associated with administering wagering games. Accordingly, the following description also discusses “services” with the understanding that the various services may be performed by different servers or combinations of servers in different embodiments. As shown in FIG. 8, the gaming servers 1610 may include a user interaction service 1612, a game service 1616, and an asset service 1614. In some embodiments, one or more of the gaming servers 1610 may communicate with an account server 1632 performing an account service 1632. As explained more fully below, for some wagering type games, the account service 1632 may be separate and operated by a different entity than the gaming servers 1610; however, in some embodiments the account service 1632 may also be operated by one or more of the gaming servers 1610.

The user device 1620 may communicate with the user interaction service 1612 through the network 1630. The user interaction service 1612 may communicate with the game service 1616 and provide game information to the user device 1620. In some embodiments, the game service 1616 may also include a game engine. The game engine may, for example, access, interpret, and apply game rules. In some embodiments, a single user device 1620 communicates with a game provided by the game service 1616, while other embodiments may include a plurality of user devices 1620 configured to communicate and provide end users with access to the same game provided by the game service 1616. In addition, a plurality of end users may be permitted to access a single user interaction service 1612, or a plurality of user interaction services 1612, to access the game service 1616. The user interaction service 1612 may enable a user to create and access a user account and interact with game service 1616. The user interaction service 1612 may enable users to initiate new games, join existing games, and interface with games being played by the user.

The user interaction service 1612 may also provide a client for execution on the user device 1620 for accessing the gaming servers 1610. The client provided by the gaming servers 1610 for execution on the user device 1620 may be any of a variety of implementations depending on the user device 1620 and method of communication with the gaming servers 1610. In one embodiment, the user device 1620 may connect to the gaming servers 1610 using a web browser, and the client may execute within a browser window or frame of the web browser. In another embodiment, the client may be a stand-alone executable on the user device 1620.

For example, the client may comprise a relatively small amount of script (e.g., JAVASCRIPT®), also referred to as a “script driver,” including scripting language that controls an interface of the client. The script driver may include simple function calls requesting information from the gaming servers 1610. In other words, the script driver stored in the client may merely include calls to functions that are externally defined by, and executed by, the gaming servers 1610. As a result, the client may be characterized as a “thin client.” The client may simply send requests to the gaming servers 1610 rather than performing logic itself. The client may receive player inputs, and the player inputs may be passed to the gaming servers 1610 for processing and executing the wagering game. In some embodiments, this may involve providing specific graphical display information for the display 1622 as well as game outcomes.

As another example, the client may comprise an executable file rather than a script. The client may do more local processing than does a script driver, such as calculating where to show what game symbols upon receiving a game outcome from the game service 1616 through user interaction service 1612. In some embodiments, portions of an asset service 1614 may be loaded onto the client and may be used by the client in processing and updating graphical displays. Some form of data protection, such as end-to-end encryption, may be used when data is transported over the network 1630. The network 1630 may be any network, such as, for example, the Internet or a local area network.

The gaming servers 1610 may include an asset service 1614, which may host various media assets (e.g., text, audio, video, and image files) to send to the user device 1620 for presenting the various wagering games to the end user. In other words, the assets presented to the end user may be stored separately from the user device 1620. For example, the user device 1620 requests the assets appropriate for the game played by the user; as another example, especially relating to thin clients, just those assets that are needed for a particular display event will be sent by the gaming servers 1610, including as few as one asset. The user device 1620 may call a function defined at the user interaction service 1612 or asset service 1614, which may determine which assets are to be delivered to the user device 1620 as well as how the assets are to be presented by the user device 1620 to the end user. Different assets may correspond to the various user devices 1620 and their clients that may have access to the game service 1616 and to different variations of wagering games.

The gaming servers 1610 may include the game service 1616, which may be programmed to administer wagering games and determine game play outcomes to provide to the user interaction service 1612 for transmission to the user device 1620. For example, the game service 1616 may include game rules for one or more wagering games, such that the game service 1616 controls some or all of the game flow for a selected wagering game as well as the determined game outcomes. The game service 1616 may include pay tables and other game logic. The game service 1616 may perform random number generation for determining random game elements of the wagering game. In one embodiment, the game service 1616 may be separated from the user interaction service 1612 by a firewall or other method of preventing unauthorized access to the game service 1612 by the general members of the network 1630.

The user device 1620 may present a gaming interface to the player and communicate the user interaction from the user input device 1624 to the gaming servers 1610. The user device 1620 may be any electronic system capable of displaying gaming information, receiving user input, and communicating the user input to the gaming servers 1610. For example, the user device 1620 may be a desktop computer, a laptop, a tablet computer, a set-top box, a mobile device (e.g., a smartphone), a kiosk, a terminal, or another computing device. As a specific, nonlimiting example, the user device 1620 operating the client may be an interactive electronic gaming system 1300. The client may be a specialized application or may be executed within a generalized application capable of interpreting instructions from an interactive gaming system, such as a web browser.

The client may interface with an end user through a web page or an application that runs on a device including, but not limited to, a smartphone, a tablet, or a general computer, or the client may be any other computer program configurable to access the gaming servers 1610. The client may be illustrated within a casino webpage (or other interface) indicating that the client is embedded into a webpage, which is supported by a web browser executing on the user device 1620.

In some embodiments, components of the gaming system 1600 may be operated by different entities. For example, the user device 1620 may be operated by a third party, such as a casino or an individual, that links to the gaming servers 1610, which may be operated, for example, by a wagering game service provider. Therefore, in some embodiments, the user device 1620 and client may be operated by a different administrator than the operator of the game service 1616. In other words, the user device 1620 may be part of a third-party system that does not administer or otherwise control the gaming servers 1610 or game service 1616. In other embodiments, the user interaction service 1612 and asset service 1614 may be operated by a third-party system. For example, a gaming entity (e.g., a casino) may operate the user interaction service 1612, user device 1620, or combination thereof to provide its customers access to game content managed by a different entity that may control the game service 1616, amongst other functionality. In still other embodiments, all functions may be operated by the same administrator. For example, a gaming entity (e.g., a casino) may elect to perform each of these functions in-house, such as providing access to the user device 1620, delivering the actual game content, and administering the gaming system 1600.

The gaming servers 1610 may communicate with one or more external account servers 1632 (also referred to herein as an account service 1632), optionally through another firewall. For example, the gaming servers 1610 may not directly accept wagers or issue payouts. That is, the gaming servers 1610 may facilitate online casino gaming but may not be part of self-contained online casino itself. Another entity (e.g., a casino or any account holder or financial system of record) may operate and maintain its external account service 1632 to accept bets and make payout distributions. The gaming servers 1610 may communicate with the account service 1632 to verify the existence of funds for wagering and to instruct the account service 1632 to execute debits and credits. As another example, the gaming servers 1610 may directly accept bets and make payout distributions, such as in the case where an administrator of the gaming servers 1610 operates as a casino.

Additional features may be supported by the gaming servers 1610, such as hacking and cheating detection, data storage and archival, metrics generation, messages generation, output formatting for different end user devices, as well as other features and operations.

FIG. 9 is a diagram of a table 1682 for implementing wagering games including a live dealer video feed, in accordance with one or more embodiments of the present disclosure. Features of the gaming system 1600 (described above in connection with FIG. 8) may be utilized in connection with this embodiment, except as further described. Rather than cards being determined by computerized random processes, physical cards (e.g., from a standard, 52-card deck of playing cards) may be dealt by a live dealer 1680 at a table 1682 from a card-handling system 1684 located in a studio or on a casino floor. A table manager 1686 may assist the dealer 1680 in facilitating play of the game by transmitting a live video feed of the dealer's actions to the user device 1620 and transmitting remote player elections to the dealer 1680. As described above, the table manager 1686 may act as or communicate with a gaming system 1600 (see FIG. 8) (e.g., acting as the gaming system 1600 itself or as an intermediate client interposed between and operationally connected to the user device 1620 and the gaming system 1600). The table manager 1683 provides gaming content at the table 1682 to users of the gaming system 1600. Thus, the table manager 1686 may communicate with the user device 1620 through a network 1630 (see FIG. 8), and may be a part of a larger online casino, or may be operated as a separate system facilitating game play. In various embodiments, each table 1682 may be managed by an individual table manager 1686 constituting a gaming device, which may receive and process information relating to that table. For simplicity of description, these functions are described as being performed by the table manager 1686, though certain functions may be performed by an intermediary gaming system 1600, such as the one shown and described in connection with FIG. 8. In some embodiments, the gaming system 1600 may match remotely located players to tables 1682 and facilitate transfer of information between user devices 1620 and tables 1682, such as wagering amounts and player option elections, without managing gameplay at individual tables. In other embodiments, functions of the table manager 1686 may be incorporated into a gaming system 1600 (see FIG. 8).

The table 1682 includes a camera 1670 and optionally a microphone 1672 to capture video and audio feeds relating to the table 1682. The camera 1670 may be trained on the live dealer 1680, play area 1687, and card-handling system 1684. As the game is administered by the live dealer 1680, the video feed captured by the camera 1670 may be shown to the player remotely using the user device 1620, and any audio captured by the microphone 1672 may be played to the player remotely using the user device 1620. In some embodiments, the user device 1620 may also include a camera, microphone, or both, which may also capture feeds to be shared with the dealer 1680 and other players. In some embodiments, the camera 1670 may be trained to capture images of the card faces, chips, and chip stacks on the surface of the gaming table. Image extraction techniques described herein (or other known techniques) may be used to obtain card count and card rank and suit information from the card images.

Card and wager data in some embodiments may be used by the table manager 1686 to determine game outcome. The data extracted from the camera 1670 may be used to confirm the card data obtained from the card-handling system 1684, to determine a player position that received a card, and for general security monitoring purposes, such as detecting player or dealer card switching, for example. Examples of card data include, for example, suit and rank information of a card, suit and rank information of each card in a hand, rank information of a hand, and rank information of every hand in a round of play.

The live video feed permits the dealer to show cards dealt by the card-handling system 1684 and play the game as though the player were at a gaming table, playing with other players in a live casino. In addition, the dealer can prompt a user by announcing a player's election is to be performed. In embodiments where a microphone 1672 is included, the dealer 1680 can verbally announce action or request an election by a player. In some embodiments, the user device 1620 also includes a camera or microphone, which also captures feeds to be shared with the dealer 1680 and other players.

The play area 1686 depicts player layouts for playing the game. As determined by the rules of the game, the player at the user device 1620 may be presented options for responding to an event in the game using a client as described with reference to FIG. 8.

Player elections may be transmitted to the table manager 1686, which may display player elections to the dealer 1680 using a dealer display 1688 and player action indicator 1690 on the table 1682. For example, the dealer display 1688 may display information regarding where to deal the next card or which player position is responsible for the next action.

In some embodiments, the table manager 1686 may receive card information from the card-handling system 1684 to identify cards dealt by the card-handling system 1684. For example, the card-handling system 1684 may include a card reader to determine card information from the cards. The card information may include the rank and suit of each dealt card and hand information.

The table manager 1686 may apply game rules to the card information, along with the accepted player decisions, to determine gameplay events and wager results. Alternatively, the wager results may be determined by the dealer 1680 and input to the table manager 1686, which may be used to confirm automatically determined results by the gaming system.

Card and wager data in some embodiments may be used by the table manager 1686 to determine game outcome. The data extracted from the camera 1670 may be used to confirm the card data obtained from the card-handling system 1684, to determine a player position that received a card, and for general security monitoring purposes, such as detecting player or dealer card switching, for example.

The live video feed permits the dealer to show cards dealt by the card-handling system 1684 and play the game as though the player were at a live casino. In addition, the dealer can prompt a user by announcing a player's election is to be performed. In embodiments where a microphone 1672 is included, the dealer 1680 can verbally announce action or request an election by a player. In some embodiments, the user device 1620 also includes a camera or microphone, which also captures feeds to be shared with the dealer 1680 and other players.

FIG. 10 is a simplified diagram showing elements of computing devices that may be used in systems and apparatuses, in accordance with one of more embodiments of the present disclosure. A computing system 1640 may be a user-type computer, a file server, a computer server, a notebook computer, a tablet, a handheld device, a mobile device, or other similar computer system for executing software. The computing system 1640 may be configured to execute software programs containing computing instructions and may include one or more processors 1642, memory 1646, one or more displays 1658, one or more user interface elements 1644, one or more communication elements 1656, and one or more storage devices 1648 (also referred to herein simply as storage 1648).

The processors 1642 may be configured to execute a wide variety of operating systems and applications including the computing instructions for administering wagering games of the present disclosure.

The processors 1642 may be configured as a general-purpose processor such as a microprocessor, but in the alternative, the general-purpose processor may be any processor, controller, microcontroller, or state machine suitable for carrying out processes of the present disclosure. The processor 1642 may also be implemented as a combination of computing devices, such as a combination of a DSP and a microprocessor, a plurality of microprocessors, one or more microprocessors in conjunction with a DSP core, or any other such configuration.

A general-purpose processor may be part of a general-purpose computer. However, when configured to execute instructions (e.g., software code) for carrying out embodiments of the present disclosure the general-purpose computer should be considered a special-purpose computer. Moreover, when configured according to embodiments of the present disclosure, such a special-purpose computer improves the function of a general-purpose computer because, absent the present disclosure, the general-purpose computer would not be able to carry out the processes of the present disclosure. The processes of the present disclosure, when carried out by the special-purpose computer, are processes that a human would not be able to perform in a reasonable amount of time due to the complexities of the data processing, decision making, communication, interactive nature, or combinations thereof for the present disclosure. The present disclosure also provides meaningful limitations in one or more particular technical environments that go beyond an abstract idea. For example, embodiments of the present disclosure provide improvements in the technical field related to the present disclosure.

The memory 1646 may be used to hold computing instructions, data, and other information for performing a wide variety of tasks including administering wagering games of the present disclosure. By way of example, and not limitation, the memory 1646 may include Synchronous Random Access Memory (SRAM), Dynamic RAM (DRAM), Read-Only Memory (ROM), Flash memory, and the like.

The display(s) 1658 may be a wide variety of displays such as, for example, light-emitting diode displays, liquid crystal displays, cathode ray tubes, and the like. In addition, the display(s) 1658 may be configured with a touch-screen feature for accepting user input as a user interface element 1644.

As nonlimiting examples, the user interface elements 1644 may include elements such as displays, keyboards, push-buttons, mice, joysticks, haptic devices, microphones, speakers, cameras, and touchscreens.

As nonlimiting examples, the communication elements 1656 may be configured for communicating with other devices or communication networks. As nonlimiting examples, the communication elements 1656 may include elements for communicating on wired and wireless communication media, such as for example, serial ports, parallel ports, Ethernet connections, universal serial bus (USB) connections, IEEE 1394 (“firewire”) connections, TH UN DERBOLT™ connections, BLUETOOTH® wireless networks, ZigBee wireless networks, 802.11 type wireless networks, cellular telephone/data networks, fiber optic networks and other suitable communication interfaces and protocols.

The storage 1648 may be used for storing relatively large amounts of nonvolatile information for use in the computing system 1640 and may be configured as one or more storage devices. By way of example and not limitation, these storage devices may include computer-readable media (CRM). This CRM may include, but is not limited to, magnetic and optical storage devices such as disk drives, magnetic tape, CDs (compact discs), DVDs (digital versatile discs or digital video discs), and semiconductor devices such as RAM, DRAM, ROM, EPROM, Flash memory, and other equivalent storage devices.

A person of ordinary skill in the art will recognize that the computing system 1640 may be configured in many different ways with different types of interconnecting buses between the various elements. Moreover, the various elements may be subdivided physically, functionally, or a combination thereof. As one nonlimiting example, the memory 1646 may be divided into cache memory, graphics memory, and main memory. Each of these memories may communicate directly or indirectly with the one or more processors 1642 on separate buses, partially combined buses, or a common bus.

As a specific, nonlimiting example, various methods and features of the present disclosure may be implemented in a mobile, remote, or mobile and remote environment over one or more of Internet, cellular communication (e.g., Broadband), near field communication networks and other communication networks referred to collectively herein as an iGaming environment. The iGaming environment may be accessed through social media environments such as FACEBOOK® and the like. DragonPlay Ltd, acquired by Bally Technologies Inc., provides an example of a platform to provide games to user devices, such as cellular telephones and other devices utilizing ANDROID®, iPHONE® and FACEBOOK® platforms. Where permitted by jurisdiction, the iGaming environment can include pay-to-play (P2P) gaming where a player, from their device, can make value based wagers and receive value based awards. Where P2P is not permitted the features can be expressed as entertainment only gaming where players wager virtual credits having no value or risk no wager whatsoever such as playing a promotion game or feature.

Some embodiments described herein are described in association with a gaming table (e.g., gaming table 101). However, other embodiments can include detecting gaming activity (e.g., player presence, player focus on a given feature, player betting, bonus events, etc.) at a gaming machine (see FIG. 11). A processor can execute instructions to perform operations that cause the gaming system (e.g., via tracking controller 204 and/or via messaging coordinator 214) to generate one or more messages and present them at the gaming system (e.g., via a secondary display, via a player interface device, via a mobile gaming application, etc.). The gaming machine can detect subsequent gaming activity that occurs at the gaming machine after the presentation of any of the messages (e.g., the subsequent gaming activity can be related to a same game feature tracked or game event detected prior to presentation of the message). The gaming system can further evaluate (e.g., via effectiveness evaluator 216) the effectiveness of the presentation of the messages over time (e.g., via automated detection of gaming activity that occurs before and after presentation of messages). The gaming system can generate an effectiveness score and use the effectiveness score to generate reports, generate additional messages, etc.

Turning now to FIG. 11, there is shown a diagram of a gaming-machine architecture in accordance with an embodiment of the present disclosure. The gaming machine architecture includes a gaming machine 1010, which includes game-logic circuitry 1040 securely housed within a locked box inside a gaming cabinet. The game-logic circuitry 1040 includes a central processing unit (CPU) 1042 connected to a main memory 1044 that comprises one or more memory devices. The CPU 1042 includes any suitable processor(s), such as those made by Intel and AMD. By way of example, the CPU 1042 includes a plurality of microprocessors including a master processor, a slave processor, and a secondary or parallel processor. Game-logic circuitry 1040, as used herein, comprises any combination of hardware, software, or firmware disposed in or outside of the gaming machine 1010 that is configured to communicate with or control the transfer of data between the gaming machine 1010 and a bus, another computer, processor, device, service, or network. The game-logic circuitry 1040, and more specifically the CPU 1042, comprises one or more controllers or processors and such one or more controllers or processors need not be disposed proximal to one another and may be located in different devices or in different locations. The game-logic circuitry 1040, and more specifically the main memory 1044, comprises one or more memory devices which need not be disposed proximal to one another and may be located in different devices or in different locations. The game-logic circuitry 1040 is operable to execute all of the various gaming methods and other processes disclosed herein. The main memory 1044 includes a wagering-game unit 1046. In one embodiment, the wagering-game unit 1046 causes wagering games to be presented, such as video poker, video black jack, video slots, video lottery, etc., in whole or part.

The game-logic circuitry 1040 is also connected to an input/output (I/O) bus 1048, which can include any suitable bus technologies, such as an AGTL+ frontside bus and a PCI backside bus. The I/O bus 1048 is connected to various input devices 1050, output devices 1052, and input/output devices 1054 such as those discussed above in connection with FIG. 1. The I/O bus 1048 is also connected to a storage unit 1056 and an external-system interface 1058, which is connected to one or more external systems (external system(s) 1060) (e.g., wagering-game networks).

The external system(s) 1060 include, in various aspects, a gaming network, other gaming machines or terminals, a gaming server, a remote controller, communications hardware, or a variety of other interfaced systems or components, in any combination. In yet other aspects, the external system(s) 1060 comprise a player's portable electronic device (e.g., cellular phone, electronic wallet, etc.) and the external-system interface 1058 is configured to facilitate wireless communication and data transfer between the portable electronic device and the gaming machine 1010, such as by a near-field communication path operating via magnetic-field induction or a frequency-hopping spread spectrum RF signals (e.g., Bluetooth, etc.).

The gaming machine 1010 optionally communicates with the external system(s) 1060 such that the gaming machine 1010 operates as a thin, thick, or intermediate client. The game-logic circuitry 1040—whether located within (“thick client”), external to (“thin client”), or distributed both within and external to (“intermediate client”) the gaming machine 1010—is utilized to provide a wagering game on the gaming machine 1010. In general, the main memory 1044 stores programming for a random number generator (RNG), game-outcome logic, and game assets (e.g., art, sound, etc.)—all of which obtained regulatory approval from a gaming control board or commission and are verified by a trusted authentication program in the main memory 1044 prior to game execution. The authentication program generates a live authentication code (e.g., digital signature or hash) from the memory contents and compare it to a trusted code stored in the main memory 1044. If the codes match, authentication is deemed a success and the game is permitted to execute. If, however, the codes do not match, authentication is deemed a failure that must be corrected prior to game execution. Without this predictable and repeatable authentication, the gaming machine 1010, external system(s) 1060, or both are not allowed to perform or execute the RNG programming or game-outcome logic in a regulatory-approved manner and are therefore unacceptable for commercial use. In other words, through the use of the authentication program, the game-logic circuitry facilitates operation of the game in a way that a person making calculations or computations could not.

When a wagering-game instance is executed, the CPU 1042 (comprising one or more processors or controllers) executes the RNG programming to generate one or more pseudo-random numbers. The pseudo-random numbers are divided into different ranges, and each range is associated with a respective game outcome. Accordingly, the pseudo-random numbers are utilized by the CPU 1042 when executing the game-outcome logic to determine a resultant outcome for that instance of the wagering game. The resultant outcome is then presented to a player of the gaming machine 1010 by accessing the associated game assets, required for the resultant outcome, from the main memory 1044. The CPU 1042 causes the game assets to be presented to the player as outputs from the gaming machine 1010 (e.g., audio and video presentations). Instead of a pseudo-RNG, the game outcome may be derived from random numbers generated by a physical RNG that measures some physical phenomenon that is expected to be random and then compensates for possible biases in the measurement process. Whether the RNG is a pseudo-RNG or physical RNG, the RNG uses a seeding process that relies upon an unpredictable factor (e.g., human interaction of turning a key) and cycles continuously in the background between games and during game play at a speed that cannot be timed by the player. Accordingly, the RNG cannot be carried out manually by a human and is integral to operating the game.

The gaming machine 1010 may be used to play central determination games, such as electronic pull-tab and bingo games. In an electronic pull-tab game, the RNG is used to randomize the distribution of outcomes in a pool and/or to select which outcome is drawn from the pool of outcomes when the player requests to play the game. In an electronic bingo game, the RNG is used to randomly draw numbers that players match against numbers printed on their electronic bingo card.

The gaming machine 1010 may include additional peripheral devices or more than one of each component shown in FIG. 11. Any component of the gaming-machine architecture includes hardware, firmware, or tangible machine-readable storage media including instructions for performing the operations described herein. Machine-readable storage media includes any mechanism that stores information and provides the information in a form readable by a machine (e.g., gaming terminal, computer, etc.). For example, machine-readable storage media includes read only memory (ROM), random access memory (RAM), magnetic-disk storage media, optical storage media, flash memory, etc.

In accord with various methods of conducting a wagering game on a gaming system in accord with the present concepts, the wagering game includes a game sequence in which a player makes a wager and a wagering-game outcome is provided or displayed in response to the wager being received or detected. The wagering-game outcome, for that particular wagering-game instance, is then revealed to the player in due course following initiation of the wagering game. The method comprises the acts of conducting the wagering game using a gaming apparatus following receipt of an input from the player to initiate a wagering-game instance. The gaming machine 1010 then communicates the wagering-game outcome to the player via one or more output devices (e.g., via a primary display or a secondary display) through the display of information such as, but not limited to, text, graphics, static images, moving images, etc., or any combination thereof. In accord with the method of conducting the wagering game, the game-logic circuitry 1040 transforms a physical player input, such as a player's pressing of a “Spin” touch key or button, into an electronic data signal indicative of an instruction relating to the wagering game (e.g., an electronic data signal bearing data on a wager amount).

In the aforementioned method, for each data signal, the game-logic circuitry 1040 is configured to process the electronic data signal, to interpret the data signal (e.g., data signals corresponding to a wager input), and to cause further actions associated with the interpretation of the signal in accord with stored instructions relating to such further actions executed by the controller. As one example, the CPU 1042 causes the recording of a digital representation of the wager in one or more storage media (e.g., storage unit 1056), the CPU 1042, in accord with associated stored instructions, causes the changing of a state of the storage media from a first state to a second state. This change in state is, for example, effected by changing a magnetization pattern on a magnetically coated surface of a magnetic storage media or changing a magnetic state of a ferromagnetic surface of a magneto-optical disc storage media, a change in state of transistors or capacitors in a volatile or a non-volatile semiconductor memory (e.g., DRAM, etc.). The noted second state of the data storage media comprises storage in the storage media of data representing the electronic data signal from the CPU 1042 (e.g., the wager in the present example). As another example, the CPU 1042 further, in accord with the execution of the stored instructions relating to the wagering game, causes a primary display, other display device, or other output device (e.g., speakers, lights, communication device, etc.) to change from a first state to at least a second state, wherein the second state of the primary display comprises a visual representation of the physical player input (e.g., an acknowledgement to a player), information relating to the physical player input (e.g., an indication of the wager amount), a game sequence, an outcome of the game sequence, or any combination thereof, wherein the game sequence in accord with the present concepts comprises acts described herein. The aforementioned executing of the stored instructions relating to the wagering game is further conducted in accord with a random outcome (e.g., determined by the RNG) that is used by the game-logic circuitry 1040 to determine the outcome of the wagering-game instance. In at least some aspects, the game-logic circuitry 1040 is configured to determine an outcome of the wagering-game instance at least partially in response to the random parameter.

In one embodiment, the gaming machine 1010 and, additionally or alternatively, the external system(s) 1060 (e.g., a gaming server), means gaming equipment that meets the hardware and software requirements for fairness, security, and predictability as established by at least one state's gaming control board or commission. Prior to commercial deployment, the gaming machine 1010, the external system(s) 1060, or both and the casino wagering game played thereon may need to satisfy minimum technical standards and require regulatory approval from a gaming control board or commission (e.g., the Nevada Gaming Commission, Alderney Gambling Control Commission, National Indian Gaming Commission, etc.) charged with regulating casino and other types of gaming in a defined geographical area, such as a state. By way of non-limiting example, a gaming machine in Nevada means a device as set forth in NRS 463.0155, 463.0191, and all other relevant provisions of the Nevada Gaming Control Act, and the gaming machine cannot be deployed for play in Nevada unless it meets the minimum standards set forth in, for example, Technical Standards 1 and 2 and Regulations 5 and 14 issued pursuant to the Nevada Gaming Control Act. Additionally, the gaming machine and the casino wagering game must be approved by the commission pursuant to various provisions in Regulation 14. Comparable statutes, regulations, and technical standards exist in other gaming jurisdictions. As can be seen from the description herein, the gaming machine 1010 may be implemented with hardware and software architectures, circuitry, and other special features that differentiate it from general-purpose computers (e.g., desktop PCs, laptops, and tablets).

FIG. 3 and FIG. 4 described by way of example above, represent data processing methods (e.g., algorithms) that corresponds to at least some instructions stored and executed by a processor and/or logic circuitry associated with the gaming system 100, the gaming system 200, the gaming system 1600, the table 1682, the computing system 1640, or the gaming machine 1010.

Any component of any embodiment described herein may include hardware, software, or any combination thereof.

Further, the operations described herein can be performed in any sensible order. Any operations not required for proper operation can be optional. For example, an effectiveness score of messages is used to generate reports (e.g., as in processing block 416) or to generate additional messages (e.g., as in processing block 418). Furthermore, in other embodiments, the gaming system can use the detected gaming activity to determine a level of game performance or a degree of player engagement, to generate quantifiable marketing content value, etc. For example, the gaming system can provide a feature for a patron account or identifier to subscribe to certain messages and get notifications on a personal device such as a smartphone. For instance, in baccarat, playing streaks are popular. The gaming system can provide a message to a patron that a streak is in progress at a specific table. Likewise, a casino operator might be interested in promoting the fact that a certain amount of money was won on side bets in a certain pit within a certain amount of time (e.g., within the last hour). The message can be displayed on various output devices (e.g., via the aforementioned CoolSign® digital signage network). In another embodiment, the gaming system can, based on a detected number of participants at a gaming table, send messages to presentation devices not associated with a gaming table. For example, a processor of a gaming system can perform operations to determine the effectiveness of messaging at a given table and send the effectiveness report to a casino-employee device. The effectiveness report can be used to determine how to manage casino devices (e.g., to determine whether to open or close tables). For example, the processor can generate and send a report to a device of a casino-floor employee. The report can indicate, based on a specific floor-management strategy, to either open another table on the casino floor or not open another table on the casino floor based on the number of players at a given table (e.g., one floor-management strategy includes a preference to have five players at one table instead of three players at one table and two players at another table).

Further, all methods described herein can also be stored as instructions on a computer readable storage medium, which instructions are operable by a computer processor. All variations and features described herein can be combined with any other features described herein without limitation. All features in all documents incorporated by reference herein can be combined with any feature(s) described herein, and also with all other features in all other documents incorporated by reference, without limitation.

The technology discussed herein makes reference to computer-based systems and actions taken by and information sent to and from computer-based systems. One of ordinary skill in the art will recognize that the inherent flexibility of computer-based systems allows for a great variety of possible configurations, combinations, and divisions of tasks and functionality between and among components. For instance, processes discussed herein can be implemented using a single computing device or multiple computing devices working in combination. Databases, memory, instructions, and applications can be implemented on a single system or distributed across multiple systems. Distributed components can operate sequentially or in parallel.

Although specific features of various embodiments may be shown in some drawings and not in others, this is for convenience only. In accordance with the principles of the present disclosure, any feature of a drawing may be referenced and/or claimed in combination with any feature of any other drawing.

This written description uses examples to disclose the claimed subject matter, including the best mode, and also to enable any person skilled in the art to practice the claimed subject matter, including making and using any devices or systems and performing any incorporated methods. The patentable scope of the disclosed technology is defined by the claims, and may include other examples that occur to those skilled in the art. Such other examples are intended to be within the scope of the claims if they include structural elements that do not differ from the literal language of the claims, or if they include equivalent structural elements with insubstantial differences from the literal languages of the claims.

What is claimed is:

1. A method comprising:
presenting, via an output device at a gaming table during an evaluation period, messages related to a game feature available at one or more participant stations at the gaming table;
detecting, for the evaluation period by an electronic processor based on analysis of images of the gaming table by one or more machine learning models, gaming activity associated with the game feature;
determining, in response to comparison of message data to gaming activity data by the electronic processor, a statistical correlation between presentation of the messages and the gaming activity; and
computing, by the electronic processor based on the statistical correlation, a message effectiveness score for one or more of the messages in relation to the game feature.

2. The method of claim 1, wherein the presenting the messages comprises recording a first set of time stamps when the messages are presented, wherein the detecting the gaming activity comprises recording a second set of time stamps when the gaming activity is detected, and wherein determining the statistical correlation between presentation of the messages and the gaming activity comprises determining that at least some of the second set of time stamps are within a specified response period after at least some of the first set of time stamps.

3. The method of claim 2, wherein each of the messages has a message identifier associated with a different type of message, wherein the computing the message effectiveness score comprises increasing a message effectiveness score, for each message identifier, when a time stamp, for the message identifier, occurs within the specified response period.

4. The method of claim 1, wherein the determining the statistical correlation comprises detecting, during the evaluation period, additional gaming activity, and determining, by the electronic processor, a difference in the additional gaming activity compared to the gaming activity, and wherein the computing the message effectiveness score comprises computing the message effectiveness score based on the difference.

5. The method of claim 4, wherein detecting the difference comprises detecting a change in a betting level over the evaluation period, and wherein computing the message effectiveness score based on the detected difference comprises computing a percentage value that represents the change in the betting level.

6. The method of claim 1 further comprising:
generating, by the electronic processor, a report that indicates the message effectiveness score; and
presenting the report via the output device.

7. The method of claim 1 further comprising:
generating, by the electronic processor using the message effectiveness score, one or more additional messages related to the game feature;
presenting the one or more additional messages via the output device at the gaming table during an additional evaluation period;
detecting, by the one or more machine learning models during the additional evaluation period after presentation of the one or more additional messages, additional gaming activity associated with the game feature; and
modifying, by the electronic processor based at least in part on comparison of the additional gaming activity to the gaming activity, the message effectiveness score.

8. The method of claim 1, wherein detecting the gaming activity comprises:
detecting, via analysis of the images by the one or more machine learning models, cards values of playing cards dealt to the one or more participant stations;
comparing, by the electronic processor, the card values to game rules; and
determining, by the electronic processor based on the comparing, one or more game outcomes associated with the one or more participant stations, and
wherein generating the one or more additional messages comprises generating, by the electronic processor, a reference to the one or more game outcomes.

9. The method of claim 8, wherein determining the one or more game outcomes associated with the one or more participant stations comprises:
detecting, via the one or more machine learning models, a rank and suit of the playing cards dealt to the one or more participant stations; and
comparing, by the electronic processor, the rank and suit to outcome criteria for a wagering game associated with the game feature.

10. The method of claim 9, wherein detecting the rank and suit of the playing cards dealt to the one or more participant stations comprises:
transforming, by the one or more machine learning models, symbol features of images of the playing cards dealt to the one or more participant stations;
detecting, based on the transforming, symbols on the playing cards; and
comparing, by the electronic processor, the detected symbols to symbols for a known rank and suit of the playing cards.

11. The method of claim 1 further comprising detecting by the electronic processor, as the gaming activity one or more of playing information, betting information, or game outcome information.

12. The method of claim 1 further comprising one or more of:
detecting by the electronic processor, as the gaming activity, one or more of card placement information at the one or more participant stations or card values of playing cards dealt to the one or more participant stations;
detecting by the electronic processor, as the gaming activity, placement of one or more betting tokens at one or more bet zones of the one or more participant stations; or
detecting by the electronic processor, as the gaming activity, bet values of betting tokens placed at one or more bet zones of the one or more participant stations.

13. A gaming system comprising:
one or more image sensors, wherein the one or more image sensors are configured to capture images at a gaming table; and
an electronic processor configured to execute instructions, which when executed cause the gaming system to perform operations to
present, via an output device at the gaming table, messages related to a game feature available at the gaming table,
detect, based on analysis of the images, gaming activity associated with the game feature,
determine a correlation between a timing of presentation of the messages and a timing of occurrence of the gaming activity, and
determine, based on the correlation, a message effectiveness score for one or more of the messages in relation to the game feature.

14. The gaming system of claim 13, wherein instructions to cause the gaming system to perform operations to determine the correlation between the timing of presentation of the messages and the timing of occurrence of the gaming activity includes instructions, which when executed by the electronic processor, cause the gaming system to perform operations to determine that one or more time stamps for gaming events occur within a response period to one or more times stamps for the messages.

15. The gaming system of claim 14, wherein the messages have identifiers associated with different classifications, wherein the instructions to cause the gaming system to perform operations to compute the message effectiveness score comprises instructions to cause the gaming system to perform operations to increase a message effectiveness score, for each message identifier, when a time stamp for the message identifier occurs within the response period.

16. The gaming system of claim 13, wherein instructions to cause the gaming system to perform operations to determine the message effectiveness score includes instructions, which when executed by the electronic processor, cause the gaming system to perform operations to:
detect, during the evaluation period, additional gaming activity;
determine a difference in the additional gaming activity compared to the gaming activity; and
compute the effectiveness score based on the difference.

17. The gaming system of claim 16, wherein instructions to cause the gaming system to perform operations to detect the difference includes instructions, which when executed by the electronic processor, cause the gaming system to perform operations to detect a change in a betting level over the evaluation period, and wherein instructions to cause the gaming system to perform operations to compute the effectiveness score based on the detected difference includes instructions, which when executed by the electronic processor, cause the gaming system to perform operations to compute a percentage value that represents the change in the betting level.

18. The gaming system of claim 13, wherein the electronic processor is further configured to execute instructions that cause the gaming system to perform operations to:
generate, using the effectiveness score, additional messages related to the game feature;
present the additional messages via the output device at the gaming table;
detect, by the one or more machine learning models, additional gaming activity associated with the game feature; and
modify, based on comparison of the additional gaming activity to the gaming activity, the message effectiveness score.

19. The gaming system of claim 13, wherein the electronic processor is further configured to execute instructions that cause the gaming system to perform operations to detect as the gaming activity, one or more of playing information, betting information, or game outcome information.

20. The gaming system of claim 13, wherein instructions to cause the gaming system to perform operations to detect the gaming activity includes instructions, which when executed by the electronic processor, cause the gaming system to perform operations to:
detect, via analysis of the images by the one or more machine learning models, cards values of playing cards dealt to the one or more participant stations;
compare the card values to game rules; and
determine, in response to comparison of the card values to game rules, one or more game outcomes associated with the one or more participant stations, and
wherein the electronic processor is further configured to execute instructions that cause the gaming system to perform operations to incorporate into at least some of the messages one or more references to the one or more game outcomes.
